(19) United States
(12) Patent Application Publication
(10) Pub. No.: US 2018/0245763 A1
(43) Pub. Date: Aug. 30, 2018

(54) LIGHTING APPARATUS

(71) Applicant: MITSUBISHI ELECTRIC CORPORATION, Tokyo (JP)

(72) Inventors: Ritsuya OSHIMA, Tokyo (JP); Akihiro YAMADA, Tokyo (JP); Masashige SUWA, Tokyo (JP); Masatoshi NISHIMURA, Tokyo (JP); Keiji NAKAMURA, Tokyo (JP)

(73) Assignee: MITSUBISHI ELECTRIC CORPORATION, Tokyo (JP)

(21) Appl. No.: 15/753,682

(22) PCT Filed: Aug. 18, 2016
(86) PCT No.: PCT/JP2016/074063

§ 371 Date: Feb. 20, 2018

(30) Foreign Application Priority Data
Aug. 21, 2015 (JP) 2015-163857

(51) Int. Cl. F21S 43/236; F21V 8/00

(52) U.S. Cl. CPC F21S 43/236; G02B 6/0031

(57) ABSTRACT

A lighting apparatus includes a light source unit and a light guide unit. The light source unit includes a light source that emits light. The light guide unit includes a reflective surface that changes a traveling direction of the light to produce reflected light, and guides the light emitted from the light source unit to make the light reach the reflective surface. A plurality of the reflective surfaces-is provided. The light source unit selects one of the plurality of reflective surfaces and emits the light to the selected reflective surface. Thus it is possible to prevent an increase in the number of places where light sources are disposed and to change light-emitting regions on the light guide unit.

### TECHNICAL FIELD

The present invention relates to a lighting apparatus using a light guide member.

### BACKGROUND ART

There is a lighting apparatus including a light source and a light guide member. The light guide member receives light emitted from the light source, guides the received light, and emits the light forward.

For example, Patent Reference 1 shows a vehicle lamp device that uses a plate-like light guide member having a light entrance part at either end thereof and emits uniform light forward relative to the vehicle. A light source is disposed to face the light entrance part. The light guide member of the vehicle lamp device is disposed inside a housing of the lamp device in such a manner that the light guide member inclines from the front toward the rear from the inner side of the vehicle toward the outer side of the vehicle. In this way, by using the light guide member, the shape of a light-emitting unit can be determined relatively freely.

### PRIOR ART REFERENCE

### Patent Reference

Patent Reference 1: Japanese Patent Application Publication No. 2011-258350 (FIG. 1)

### SUMMARY OF THE INVENTION

### Problem to be Solved by the Invention

However, it is possible to improve designability or functionality of a lighting apparatus by dynamically changing light-emitting regions. Meanwhile, in order to dynamically emit light from the light-emitting regions, multiple light sources are provided and arranged in different positions, for example. Thus light emissions corresponding to the light-emitting regions can be achieved. In this case, multiple light sources are needed. The multiple light sources are arranged in different places in the lighting apparatus. Therefore, the lighting apparatus is complex in structure.

The present invention makes it possible to change light-emitting regions on a light guide unit, in a lighting apparatus using a light guide member while preventing places where light sources are disposed from increasing.

### Means of Solving the Problem

A lighting apparatus according to the present invention includes a first light source unit including a first light source that emits first light; and a light guide unit including a first reflective surface that changes a traveling direction of light to produce first reflected light and guiding the first light emitted from the first light source unit to make the first light reach the first reflective surface, wherein a plurality of the first reflective surfaces is provided, and the first light source unit selects one of the plurality of first reflective surfaces and emits the first light to illuminate the selected first reflective surface.

### Effects of the Invention

According to this, it is possible to change light-emitting regions on a light guide unit while preventing places where light sources are disposed from increasing.

### BRIEF DESCRIPTION OF THE DRAWINGS

FIG. 1 is a configuration diagram illustrating a lighting apparatus 105 according to embodiment 1.

FIG. 2 is a configuration diagram illustrating a lighting apparatus 106 according to variation 1 of embodiment 1.

FIG. 3 is a configuration diagram illustrating a lighting apparatus 107 according to variation 2 of embodiment 1.

FIG. 4 is a configuration diagram illustrating a lighting apparatus 100 according to embodiment 2.

FIG. 5 is a configuration diagram illustrating a lighting apparatus 101 according to variation 3 of embodiment 2.

FIG. 6 is a configuration diagram illustrating a lighting apparatus 102 according to variation 4 of embodiment 2.

FIG. 7 is a configuration diagram illustrating a lighting apparatus 103 according to variation 5 of embodiment 2.

FIG. 8 is a configuration diagram illustrating a lighting apparatus 104 according to variation 6 of embodiment 2.

FIG. 9 is a configuration diagram illustrating a lighting apparatus 108 according to variation 6 of embodiment 2.

FIG. 10 is a configuration diagram illustrating a lighting apparatus 109 according to variation 6 of embodiment 2.

FIG. 11 is a schematic diagram illustrating a vehicle on which lighting apparatuses 100 are mounted.

### MODE FOR CARRYING OUT THE INVENTION

From the viewpoint of reduction of the environmental burdens such as reduction of carbon dioxide (002) emissions and fuel consumption, energy saving in vehicles has been desired. Accordingly, in respect of lighting apparatuses, downsizing, weight reduction and energy saving have also been demanded. Thus it is desired to use a semiconductor light source with higher light emission efficiency than a conventional halogen bulb (lamp light source), as a light source for a lighting apparatus. The “semiconductor light source” is, for example, a light-emitting diode (LED), a laser diode (LD) or the like.

A light source such as an organic electroluminescence (organic EL) or a light source that achieves light emission by irradiating a fluorescent substance applied onto a flat surface with excitation light are also called a solid-state light source. A semiconductor light source is a kind of the solid-state light source.

The following embodiments will be described by assuming that the light sources are solid-state light sources. The solid-state light sources can be used as the light sources.

There is a lighting apparatus including a light source and a light guide unit that receives light emitted from the light source, guides the received light, and emits the light forward. The lighting apparatus uses the light guide unit and thereby emits light from the light guide unit. The shape of a light guide member used in the light guide unit determines the shape of a light-emitting body. The shape of the light guide member can be determined relatively freely. Thus a lighting apparatus having high designability can be realized. The light that has entered the light guide member travels inside of the light guide member while it is reflected by inner surfaces of the light guide unit. Furthermore, it is conceivable that by optically controlling the shape of the light guide member, light is emitted from an arbitrary region on the light guide unit.

It is also conceivable that the lighting apparatus is formed by providing the light guide unit with multiple light sources to make a light guide body emit light. In this apparatus, by controlling timing of light emissions of the light sources and continuously switching on and off the light sources, light-emitting regions can be changed dynamically. Thus a lighting apparatus having not only high designability but also high functionality can be obtained.

The vehicle lamp device in Patent Reference 1 is a lighting apparatus using a light guide member. In this lighting apparatus, light enters through both ends of the light guide member and the light guide member thus emits light. Patent Reference 1 describes a configuration in which light enters through the both ends of the light guide member, the light is reflected by inner surfaces of the light guide member and the light is emitted forward via a prism surface provided in the light guide member.

Furthermore, Japanese Patent Application Publication No. 2013-16386 describes a configuration of a vehicle lamp device that includes a plurality of light-emitting diodes provided on an end surface of a light guide plate and emits light from the light guide plate as a whole.

By dynamically changing the light-emitting regions, the designability and the functionality of a lighting apparatus can be improved. However, in order to emit light from the light-emitting regions dynamically, a configuration for separately emitting light from the light-emitting regions is needed. For example, this can be realized by using a configuration that includes multiple light sources and enables light emission corresponding to each light-emitting region. However, since the multiple light sources are needed, the number of parts increases and the structure is complex.

If the light sources are disposed near the light-emitting regions, the structure of the lighting apparatus is complex, including the arrangement of electronic components for turning on the light sources, substrates, and so on.

In the embodiments described below, a lighting apparatus using a light guide unit dynamically changes light-emitting regions and downsizing of the lighting apparatus is thus achieved. In other words, a lighting apparatus that dynamically changes light-emitting regions is achieved with a simple configuration.

In the embodiments described below, by selectively illuminating a plurality of optical control surfaces with light entering the light guide unit from a single light source unit, light-emitting regions on the light guide unit can be changed. It is also possible to emit light from the entire light guide unit by quickly changing a direction of the incident light.

In the following embodiments, for ease of description, XYZ orthogonal coordinate axes are illustrated in the drawings.

In the following description, a forward direction of the lighting apparatus is a +Z axis direction, and a backward direction of the lighting apparatus is a −Z axis direction. The forward direction of the lighting apparatus is a direction in which illumination light is emitted. An upper side of the lighting apparatus is a side in a +Y axis direction, and a lower side of the lighting apparatus is a side in a −Y axis direction. When the lighting apparatus is directed forward, a right side of the lighting apparatus is a side in a +X axis direction and a left side of the lighting apparatus 105 is a side in a −X axis direction.

In the following embodiments, light emitted from a light source unit is mainly emitted in the +X axis direction. Light traveling inside of a light guide member mainly travels in the +X axis direction.

When the lighting apparatus is seen from behind, a clockwise direction around the Z axis is a +RZ direction, and a counterclockwise direction around the Z axis is a −RZ direction. When the lighting apparatus is seen from the left side (−X axis direction side) to the right side (+X axis direction side), a clockwise direction around the X axis is a +RX direction and a counterclockwise direction around the X axis is a −RX direction. When the lighting apparatus is seen from the lower side (−Y axis direction side) to the upper side (+Y axis direction side), a clockwise direction around the Y axis is a +RY direction and a counterclockwise direction around the Y axis is a −RY direction.

### Embodiment 1

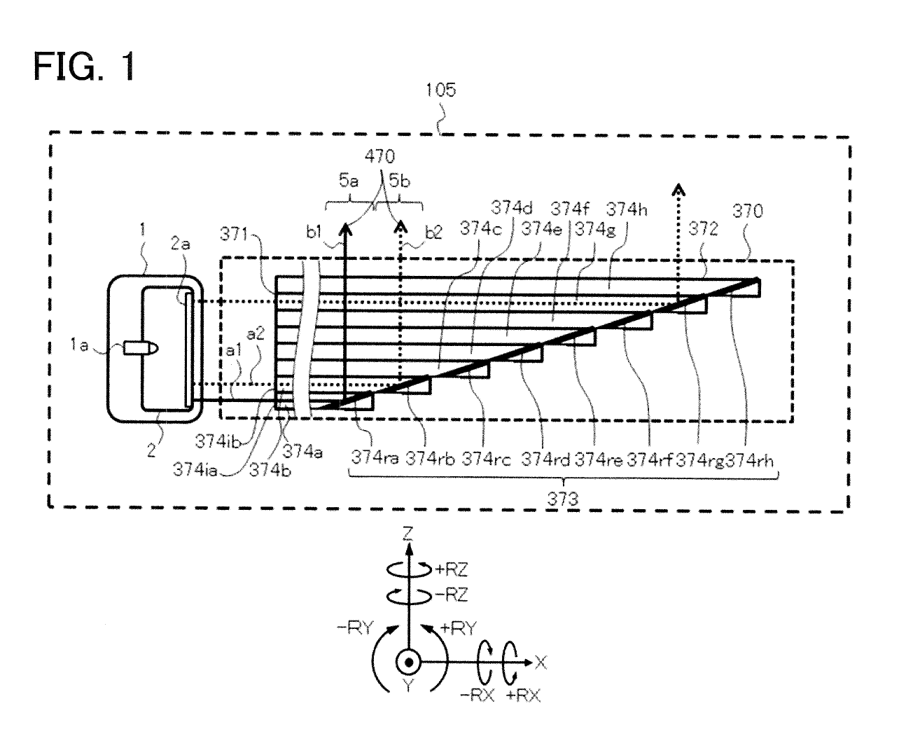

FIG. 1 is a schematic diagram illustrating a lighting apparatus 105 according to embodiment 1.

As a method for forming reflective surfaces in the lighting apparatus 105, for example, a plurality of reflective surfaces (reflective surfaces 374r) can be formed by arranging, in layers, a plurality of light guide components (light guide members 374) each having one or more reflective surfaces.

In this configuration, for example, if the reflective surfaces (reflective surfaces 374r) are diffusing surfaces, it is possible to emit strong reflected light from the reflective surfaces of one or more of the light guide components (light guide members 374) that light has entered. In addition, it is possible to emit reflected light from the reflective surfaces while increasing the uniformity of the reflected light. An example relating to this will hereinafter be described as embodiment 1.

### (Outline of Lighting Apparatus 105)

The lighting apparatus 105 includes a light source unit 1 and a light guide unit 370. The lighting apparatus 105 includes a light source 1a. The lighting apparatus 105 may include a drive device 2 (a light adjustment unit). The light source unit 1 includes the light source 1a. The light source unit 1 may include the drive device 2.

The drive device 2 enables light emitted from the light source unit 1 to be translated in the Z axis direction, for example. In other words, the light is emitted from the light source unit 1 in the +X axis direction and a position where the light is emitted from the light source unit 1 is moved in the Z axis direction. During this movement, a direction in which the light travels is kept parallel to the X axis.

The light guide unit 370 includes a reflective surface 373 at an end portion on the +X axis direction side. Further, the light guide unit 370 includes an entrance surface 371 at an end portion on the −X axis direction side.

The light guide unit 370 includes the plurality of light guide components 374. The light guide components 374 are disposed to overlap with each other in the Z axis direction. Supposing that representative light of the light emitted from the light source 1 and the drive device 2 is a light beam 470, the light beam 470 is made to selectively enter an entrance surface 374i of one light guide component of the light guide components 374 and the light beam 470 then reaches a reflective surface 374r of the one light guide component.

The light beam 470 which has reached the reflective surface 374r passes through another one or other ones of the light guide components 374 and is emitted forward (in the +Z axis direction) relative to the lighting apparatus 105.

The another one or other ones of the light guide components 374 through which the light beam 470 has passed are disposed on the +Z axis direction side from the one light guide component 374 including the reflective surface 374r at which the light beam 470 is reflected.

In this configuration, it is possible to emit reflected light from the reflective surface 374r of the light guide component 374 that light has entered. The reflective surface 374r of the light guide component 374 that light has entered can emit stronger reflected light than the other reflective surfaces 374r.

The arrangement of the plurality of light guide components 374 may be an arrangement other than the arrangement that the light guide components 374 are arranged in the Z axis direction. For example, the light guide components 374 may be disposed to overlap with each other in the Y axis direction. Alternatively, the light guide components 374 may be rotated in the −RZ direction and disposed to overlap with each other so that they form an unfolded fan shape. In other words, the arrangement of the light guide components 374 is not limited and the effects described in embodiment 1 can be obtained even if the arrangement of is changed.

In embodiment 1, light can be emitted from either a part or the whole of the light guide unit 370 while the number of the light sources 1a is small. In embodiment 1, downsizing of the entire lighting apparatus 105 can be achieved, the number of parts is reduced, and assembling performance is improved.

Embodiment 1 is not limited to a case where the drive device 2 changes the direction of the light that enters the light guide unit 370 by rotationally changing the direction of the light around the Y axis. For example, the direction of the light that enters the light guide unit 370 may be changed translationally in the ±Z axis or the ±Y axis directions. Alternatively, the direction of the light that enters the light guide unit 370 may be rotationally changed around the Z axis or the X axis. Alternatively, the direction of the light that enters the light guide unit 370 may be directions based on a combination of the above examples.

In embodiment 1, the direction of the light that enters the light guide unit 370 is changed by using the drive device 2. However, a configuration for changing the direction of the light is not limited to this. For example, by directly driving the light source unit 1 through rotation, translation or both of these operations, the direction of the light that enters the light guide unit 370 may be changed.

The direction of the light that enters the light guide unit 370 is not limited to the +X axis direction. For example, the light may enter in the −Y axis direction. In other words, the entrance surface 371 provided on the light guide unit 370 may be disposed at an arbitrary position on the light guide unit 370.

While a two-dimensionally formed configuration is adopted in embodiment 1, a three-dimensionally formed configuration may alternatively be adopted.

The drive device will be described as a light adjustment unit in each of the following embodiments. The light guide components will be described as light guide members.

In the following description, the lighting apparatus 105 will be described in detail.

### (Light Source Unit 1)

The light source unit 1 makes light enter the light guide unit 370.

For example, a light-emitting diode (LED), an electroluminescence element, a laser diode, or the like can be used as the light source 1a of the light source unit 1. Alternatively, fluorescent substance that receives excitation light and emits fluorescence can be used as the light source 1a. In a case where fluorescent substance is disposed on an optical path in the light guide unit 370, an excitation light source that excites the fluorescent substance can be used as the light source 1a.

In FIG. 1, the light source unit 1 is disposed at a position on the −X axis direction side of the light guide unit 370. For example, the light source unit 1 is disposed at a position on the −X axis direction side of an end portion of the light guide unit 370. The entrance surface 371 is formed by a surface of the −X axis direction side of the light guide unit 370. In FIG. 1, the end portion on the −X axis direction side of the light guide unit 370 is the entrance surface 371. The light source unit 1 is disposed to face the entrance surface 371.

The light source unit 1 emits light toward the end portion of the light guide unit 370.

In a case where the light source unit 1 uses a light source for emitting light with a large divergence angle such as an LED, the beam diameter can be adjusted by using a converging optical system such as a collimator lens or a converging lens. In a case where the light source unit 1 uses a light source with high directivity such as a laser diode, it can be configured without using the converging optical system. The light whose beam diameter has been adjusted enters the light adjustment unit 2.

The “divergence angle” is a spread angle of light.

### (Light Adjustment Unit 2)

The light source unit 1 can include the light adjustment unit 2. For example, the light adjustment unit 2 can change a position where the light generated by the light source 1a is emitted from the light source unit 1. The light adjustment unit 2 can change a position of the light that enters the light guide unit 370 on the entrance surface 371. The light adjustment unit 2 can make the light enter the light guide unit 370 selectively.

For example, the light adjustment unit 2 is a device that changes a traveling direction in which the light emitted from the light source unit 1 travels. By driving an optical component, the light adjustment unit 2 changes the traveling direction of the light emitted from the light source unit 1.

The optical component is, for example, a lens, a light guide member, a mirror or the like. As the mirror, a MEMS mirror, a galvanometer mirror, a polygon mirror and the like can be given as examples.

In order to change the traveling direction of the light beam, for example, the lens may be moved in a direction perpendicular to the optical axis. The lens may be rotated around an axis perpendicular to the optical axis.

In order to change the traveling direction of the light beam, for example, a light exit surface of a light guide member such as an optical fiber may be inclined. The angle of the mirror that reflects the light may be changed. The traveling direction in which reflected light travels may be changed by rotating a polygon mirror.

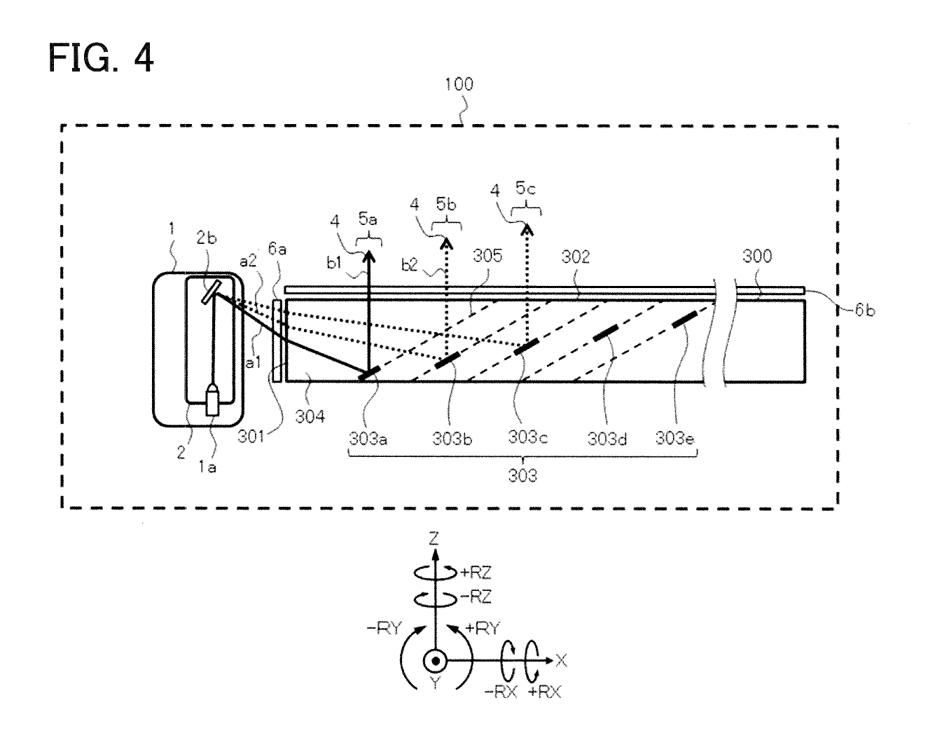

FIG. 4 simply illustrates a configuration using a mirror as an example of the light adjustment unit 2 which changes the traveling direction of the light. A light adjustment unit 2 using a mirror 2b will be described with reference to FIG. 4.

A light source 1a is disposed at a position in the −Z axis direction of the mirror 2b. A light beam 4 is emitted from the light source 1a in the +Z axis direction. The light beam 4 emitted from the light source 1a reaches the mirror 2b. The light beam 4 which has reached the mirror 2b is reflected by the mirror 2b and travels in the +X axis direction.

By rotating the mirror 2b around the Y axis, the light beam 4 can be scanned in the Z axis direction.

The light whose traveling direction has been changed enters the inside of a light guide unit 370 through a different position on an entrance surface 371.

As illustrated in FIG. 1, a liquid crystal shutter 2a may be used in the light adjustment unit 2. Next, the light adjustment unit 2 using the liquid crystal shutter 2a will be described with reference to FIG. 1.

For example, the light adjustment unit 2 includes a container having a reflective surface as its inner surface. The liquid crystal shutter 2a is provided as a part of the container.

For example, the light beam 470 emitted from the light source 1a enters the container having the reflective surface as its inner surface. If a part of the liquid crystal shutter is formed to allow transmission of the light, the light repeatedly reflected inside the container is emitted outside the container. The light-transmission part on the liquid crystal shutter 2a is changed so as to correspond to a position on the entrance surface 371. In this way, the light emitted outside the container enters the inside of the light guide unit 370 through a different position on the entrance surface 371.

Fluorescent substance may be disposed on the reflective surface as the inner surface of the container. By using an excitation light source for exciting the fluorescent substance as the light source 1a, fluorescence can be emitted from the light adjustment unit 2.

It is possible to make the light emitted from the light source unit 1 directly enter the light guide unit 370 without using the light adjustment unit 2.

For example, the entire light source unit 1 may be rotated around the Y axis. By means of this, the light whose traveling direction has been changed enters the inside of the light guide unit 370 through a different position on the entrance surface 371.

Alternatively, for example, the light source unit 1 may be moved in the Z axis direction. By means of this, the light whose emitting position has been changed enters the inside of the light guide unit 370 through a different position on the entrance surface 371.

By means of these, the number of light sources 1a included in the light source unit 1 can be reduced.

### (Light Guide Unit 370)

The light guide unit 370 includes a plurality of light guide members 374. The light guide members 374 are parts for guiding light.

For example, each of the light guide members 374 is shaped like a rod or a plate. Furthermore, the light guide members 374 are made of glass or resin, for example.

The light guide members 374 are disposed to guide the light in the +X axis direction, for example.

In a case where each of the light guide members 374 is shaped like a rod, a bundle of the light guide members 374 forms the light guide unit 370, for example. Alternatively, a stack of the light guide members 374 forms the light guide unit 370, for example.

In a case where each of the light guide members 374 is shaped like a plate, a stack of the light guide members 374 forms the light guide unit 370, for example.

In FIG. 1, the light guide unit 370 is formed by stacking the light guide members 374 in the Z axis direction.

Each of the light guide members 374 includes the entrance surface 374i. Each of the light guide members 374 has the entrance surface 374i on the −X axis direction side thereof. The entrance surface 374i receives the light emitted from the light source unit 1.

For example, a light guide member 374a includes an entrance surface 374ia. A light guide member 374b includes an entrance surface 374ib. In FIG. 1, a set of the entrance surfaces 374i of the light guide members 374 forms the entrance surface 371 of the light guide unit 370. In FIG. 1, the entrance surfaces 374i of the light guide members 374 are disposed in parallel to the Y-Z plane. The entrance surfaces 374i of the light guide members 374 are disposed on the same plane.

Each of the light guide members 374 has a reflective surface 374r. Each of the light guide members 374 has a reflective surface 374r on the +X axis direction side thereof. The reflective surface 374r reflects the light that has traveled inside of the light guide member 374.

For example, the light guide member 374a includes a reflective surface 374ra. The light guide member 374b includes a reflective surface 374rb. A set of the reflective surfaces 374r of the light guide members 374 forms the reflective surface 373 of the light guide unit 370.

The light guide members 374 are different in length from each other. In FIG. 1, every one of the light guide members 374 is longer in length than its adjacent one of the light guide members 374 on the −Z axis direction side.

For example, the length of the light guide member 374b is longer than that of the light guide member 374a. The length of the light guide member 374c is longer than that of the light guide member 374b. The length of the light guide member 374d is longer than that of the light guide member 374c.

For example, each of the reflective surfaces 374r is a surface rotated in the +RY direction from the X-Y plane. For example, assuming that the light beam 470 which has entered through the entrance surface 374i is parallel to the X axis and that the light beam 470 which has reflected by the reflective surface 374r is parallel to the Z axis, the angle of the rotation of the reflective surface 374r is 45 degrees.

In a case where the light guide member 374c is a light guide member neighboring the light guide member 374b and the light guide member 374c is a light guide member longer than the light guide member 374b, an end portion of the reflective surface 374rb on a longer side of the light guide member 374b is disposed at a position of an end portion of a reflective surface 374rc on a shorter side of the light guide member 374c.

In a case where the light guide member 374a is a light guide member neighboring the light guide member 374b and the light guide member 374a is a light guide member shorter than the light guide member 374b, an end portion of the reflective surface 374rb on a shorter side of the light guide member 374b is disposed at a position of an end portion of a reflective surface 374ra on a longer side of the light guide member 374a.

For example, the reflective surfaces 374r of the light guide members 374 form a single flat surface (the reflective surface 373).

Each of the reflective surfaces 374r of the light guide members 374 is formed at a place where two members are attached to each other. Thus part of the light guide member 374 also exists on the +X axis direction side of the reflective surface 374r. Thus in a case where the reflective surface 374r is set to reflect part of the light and to transmit the other part of light, the light can be dynamically emitted in two directions, i.e., in the +Z axis direction and the +X axis direction in the lighting apparatus 105, for example. For example, by forming the reflective surface 374r as a diffusing surface, the light which has reached the reflective surface 374r can be divided into reflected light and transmitted light.

In FIG. 1, the light beam 470 is an example of the light which has entered the entrance surface 371 of the light guide unit 470. The light beam 470 enters the inside of the light guide member 374 through the entrance surface 374i of the light guide member 374.

The light beam 470 which has entered the entrance surface 374i travels inside of the light guide member 374. The light beam 470 travels inside of the light guide member 374 while it is repeatedly totally reflected. The light beam 470 travels inside of the light guide member 374 in the +X axis direction.

The light beam 470 which has traveled inside of the light guide member 374 reaches the reflective surface 374r. The light beam 470 which has reached the reflective surface 374r is reflected by the reflective surface 374r.

The traveling direction of the light beam 470 which has been reflected by the reflective surface 374r is changed to the +Z axis direction, for example. The light beam 470 which has been reflected by the reflective surface 374r is emitted from a side surface of the light guide member 374. Then, the light beam 470 is transmitted by another one or other ones of the light guide members 374 arranged in the traveling direction (+Z axis direction) of the light beam 470. Then, the light beam 470 is emitted from the light guide unit 370. The light beam 470 is emitted from an exit surface 372 of the light guide unit 370.

The light beam 470 which has passed through the light guide members 374 is emitted forward (in the +Z axis direction) relative to the lighting apparatus 105. The light beam 470 emitted from the exit surface 372 of the light guide unit 370 is emitted forward (in the +Z axis direction) relative to of the lighting apparatus 105.

The light adjustment unit 2 selects a light guide member 374 in which the light beam 470 is guided.

For example, if the light adjustment unit 2 selects a light emission position corresponding to a path a1, the light beam 470 enters the light guide member 374a. The light beam 470 which has entered the light guide member 374a travels inside of the light guide member 374a in the +X axis direction. The light beam 470 which has traveled inside of the light guide member 374a reaches the reflective surface 374ra. The light beam 470 which has reached the reflective surface 374ra is reflected by the reflective surface 374ra. The light beam 470 which has been reflected by the reflective surface 374ra travels in the +Z axis direction (a path b1). The light beam 470 traveling in the +Z axis direction is transmitted from the light guide member 374b to the light guide member 374h. Then, the light beam 470 is emitted from the exit surface 372 of the light guide unit 370. The light beam 470 which has been emitted from the light guide unit 370 is emitted forward (in the +Z axis direction) from the lighting apparatus 105.

Next, for example, if the light adjustment unit 2 selects a light emission position corresponding to a path a2, the light beam 470 enters the light guide member 374b. The light beam 470 which has entered the light guide member 374b travels inside of the light guide member 374b in the +X axis direction. The light beam 470 which has traveled inside of the light guide member 374b reaches the reflective surface 374rb. The light beam 470 which has reached the reflective surface 374rb is reflected by the reflective surface 374rb. The light beam 470 which has been reflected by the reflective surface 374rb travels in the +Z axis direction (a path b2). The light beam 470 traveling in the +Z axis direction is transmitted from the light guide member 374c to the light guide member 374h. Then, the light beam 470 is emitted from the exit surface 372 of the light guide unit 370. The light beam 470 which has been emitted from the light guide unit 370 is emitted forward (in the +Z axis direction) from the lighting apparatus 105.

In FIG. 1, the exit surface 372 of the light guide unit 370 is a side surface of the light guide member 374h. The exit surface 372 is the side surface on the +Z axis direction side of the light guide member 374h.

The path b2 is located on the +X axis direction side of the path a2. A light-emitting region 5a is a region toward which the light beam 470 is emitted from the light guide unit 370 when the light beam 470 travels the paths a1 and b1. A light-emitting region 5b is a region toward which the light beam 470 is emitted from the light guide unit 370 when the light beam 470 travels the paths a2 and b2. The light-emitting region 5b is a region different from the light-emitting region 5a. The light-emitting region 5b is located on the +X axis direction side of the light-emitting region 5a.

By changing the position where the light beam 470 is emitted from the light source unit 1, the light adjustment unit 2 can select one of the light guide members 374 that the light beam 470 enters. That is, the light adjustment unit 2 can select one of the reflective surfaces 374r that the light beam 470 reaches. The light adjustment unit 2 can select one of the light-emitting regions 5 on the light guide unit 370, from which the light beam 470 is emitted.

In other words, the light adjustment unit 2 can change the position where the light from the light source unit 1 enters the light guide unit 370. Thus the light adjustment unit 2 can change the light-emitting region 5 on the light guide unit 370 in accordance with the change of the light emission position. The light adjustment unit 2 can change the light-emitting region 5 on the exit surface 372 in accordance with the change of the light emission position.

In other words, by temporally changing the position through which the light is emitted to the light guide unit 370, the light adjustment unit 2 can temporally change the position (the light-emitting region 5) on the light guide unit 370, from which the light is emitted. In other words, the light adjustment unit 2 allows light to be dynamically emitted through an arbitrary region on the light guide unit 370. This arbitrary region is a region corresponding to the reflective surface 374r.

In addition, the light source unit 1 can control timing of light emission by the light source 1a. The light source unit 1 can control exit timing at which the light exits from the light adjustment unit 2. For example, by controlling the liquid crystal shutter 2a, the position of the light beam 470 emitted from the light source unit 1 and the exit timing of the light beam 470 can be controlled.

By means of these, the lighting apparatus 105 can dynamically emit light.

Furthermore, for example, by using the liquid crystal shutter 2a of the light adjustment unit 2, the light adjustment unit 2 can make the light enter one or more of the light guide members 374. By means of this, the lighting apparatus 105 can emit light in a certain pattern from the exit surface 372 of the light guide unit 370. For example, the lighting apparatus 105 can display a character, a figure or the like on the exit surface 372. Furthermore, by making the light enter all of the light guide members 374, the lighting apparatus 105 can emit light from the entire exit surface 372 of the light guide unit 370.

For example, even when the light is controlled by the light adjustment unit 2, by increasing a speed of the scanning of the light, the lighting apparatus 105 can emit light in a certain pattern from the exit surface 372 of the light guide unit 370. By increasing the speed of the scanning of the light, the lighting apparatus 105 can also emit light from the entire exit surface 372 of the light guide unit 370.

The reflective surface 374r has been described as a flat surface. However, the reflective surface 374r is not limited to the flat surface. For example, the reflective surface 374r may be a curved surface. The curved surface of the reflective surface 374r may include a free-form surface, for example. For example, the reflective surface 374r may be a surface having fine prisms. By changing a surface shape of the reflective surface 374r, the range of the light-emitting region 5 on the exit surface 372 can be changed.

The configuration of the reflective surface 373 is not limited to the above configurations. A mirror, a half mirror, a dichroic mirror, a polarization mirror or the like may be used.

The end portion on the +X axis direction side of each of the light guide members 374 may be cut diagonally in order to easily form the reflective surface 374r.

In FIG. 1, the reflective surface 374r reflects the light which has traveled in the +X axis direction, in the +Z axis direction. However, it is not necessary for the direction in which the light is reflected to be a direction perpendicular to the light guide direction. The angle of the reflective surface 374r can be changed so that the light which has been reflected by the reflective surface 374r travels in a direction inclined from the direction perpendicular to the light guide direction.

By providing the entrance surface 374i with a shape for diffusing the light such as a prism, the divergence angle of the incident light can be increased. By providing the entrance surface 374i with a lens shape, the divergence angle of the incident light can be changed. A lens, a prism, a diffusion element, or the like may be additionally disposed at a position of the entrance surface 371i.

By controlling the divergence angle of the light at a time when the light enters the light guide member 374, the number of times of reflections that occur when the light propagates inside the light guide member 374 can be increased. This makes it possible to increase the uniformity of the light intensity distribution.

In a case where the divergence angle of the light at a time of emission from the light adjustment unit 2 is large, by decreasing the divergence angle with a lens or the like, it is possible to improve efficiency of entering the light guide member 374.

The arrangement of the plurality of light guide members 370 may be an arrangement other than the arrangement that the light guide members 370 are arranged in the Z axis direction. For example, an arrangement that the plurality of light guide members 370 is stacked in the Y axis direction may be used.

Alternatively, for example, the light guide members 374 may be arranged so as to form a fan-like shape, by rotating the light guide members 374 in the −RZ direction around the entrance surfaces 374i. In this case, the entrance surface 371 can be made to be a flat surface, by providing each of the entrance surfaces 374i with an inclination.

In other words, as long as the entrance surface 374i is disposed at a region, on which the light emitted from the light source unit 1 impinges, the arrangement of the light guide members 374 is not limited to a particular arrangement. Regarding the arrangement of the plurality of light guide members 374, similar arrangement is applicable to other variations and the other embodiments.

The shape of the light guide member 374 is not limited to a particular shape, as long as the light can be guided and the light can be reflected by the reflective surface 374r. Regarding the shape of the light guide member 374, similar shape is applicable to other variations and the other embodiments.

For example, when a laser diode (LD) is used as the light source 1, the lighting apparatus 105 may include fluorescent substance. The fluorescent substance receives laser light and emits fluorescence.

The fluorescent substance may be disposed at a region through which the light passes. The fluorescent substance may be disposed on the reflective surface 373, for example.

Alternatively, the fluorescent substance may be disposed at a position of the exit surface 372 of the light guide unit 370, for example. Alternatively, the fluorescent substance may be disposed at the exit surface of the lighting apparatus 105, for example. The fluorescent substance may be disposed at a position of the entrance surface 371. In these cases, it is desirable that consideration be given so that there will not be so much light that does not satisfy a total reflection condition inside the light guide member 374.

An optical element for making the light emitted from the exit surface 372 converge or diverge or the like may be disposed on the +Z axis direction side of the exit surface 372.

The surface on the +Z axis direction side (the exit surface 372) on the light guide unit 370 from which the light beam 470 is emitted may be formed as a free-form surface. The exit surface 372 may have a lens shape having a lens effect. For example, the exit surface 372 may have a prism surface shape.

In the case of the light guide unit 370 illustrated in FIG. 1, the exit surface 372 is a side surface of the light guide member 374h. Thus it is not preferable that the exit surface 372 be formed to have a shape that hinders the guiding of the light beam 470. In the case of the light guide unit 370, it is desirable that an optical element be additionally disposed on the +Z axis direction side of the light guide member 374h.

Regarding the configuration of the surface (the exit surface 372) on the light guide unit through which the light beam is emitted, similar configuration is applicable to the other embodiments or other variations.

The reflective surface 373 may be formed by using a mirror, a half mirror, a dichroic mirror, a polarization mirror or the like. However, the structure of the reflective surface 373 is not limited to these. For example, the reflective surface 373 may be a diffusing surface. Regarding the configuration of the reflective surface, similar configuration is applicable to the other embodiments or other variations.

### (Variation 1)

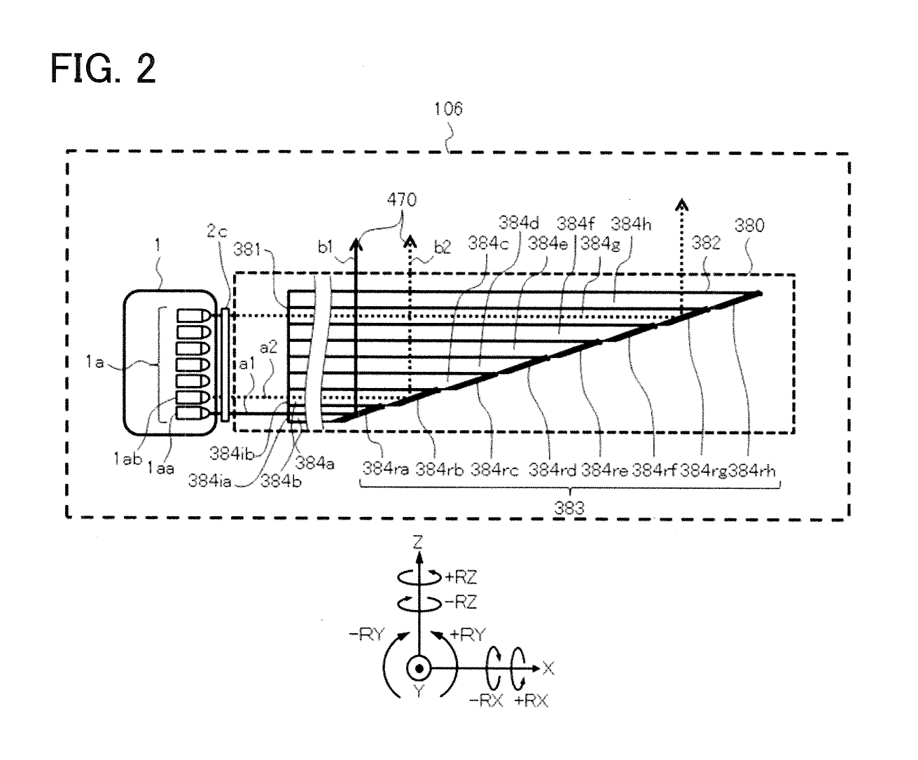

FIG. 2 is a schematic diagram illustrating a lighting apparatus 106 according to variation 1 of embodiment 1.

A light source unit 1 of the lighting apparatus 106 does not include a light adjustment unit 2. The light source unit 1 includes a plurality of light sources 1a. The light sources 1a are disposed to correspond to entrance surfaces 384i of light guide members 384. In FIG. 2, a light source 1aa is disposed to correspond to an entrance surface 384ia. A light beam 470 emitted from the light source 1aa enters a light guide member 384a through the entrance surface 384ia. A light source lab is disposed to correspond to an entrance surface 384ib. A light beam 470 emitted from the light source lab enters a light guide member 384b through the entrance surface 384ib.

By selecting the light source 1a to be turned on, the light source unit 1 can selectively illuminate an optical control surface (a reflective surface 383) with the light beam 470, which enters the light guide unit 384.

A light guide unit 380 includes the plurality of light guide members 384. A set of the entrance surfaces 384i of the light guide members 384 forms an entrance surface 381 of the light guide unit 380. A set of reflective surfaces 384r of the light guide members 384 forms the reflective surface 383 of the light guide unit 380.

Each of the reflective surfaces 384r of the light guide members 384 is formed at a portion diagonally cut when it is seen from the −Y axis direction. In this respect, the light guide members 384 are different from the light guide members 374.

For example, the reflective surfaces 384r may be formed as total reflection surfaces. Light use efficiency of a reflective surface using total reflection is higher than light use efficiency of a reflective surface using a mirror surface. The “mirror surface” is, for example, a surface obtained by coating a reflective surface with aluminum or the like through vapor deposition.

The angles of the reflective surfaces 384r are determined so that the light traveling in the +X axis direction is totally reflected by the reflective surface 383.

For example, in a case that the light adjustment unit 2 emits light with high directivity, such as a case of an LD, the reflection efficiency at the reflective surface 384r improves. However, to increase the uniformity of the light intensity distribution, for example, an optical element 2c (a diffusion element) for increasing the divergence angle may be disposed between the exit surface of the light adjustment unit 2 and the entrance surfaces 384i. For example, each of the entrance surfaces 384i may be provided with a light diffusion function.

On the other hand, in a case where the directivity of the light emitted from the light adjustment unit 2 is low, the reflection efficiency can be increased by increasing the degree of parallelization of the light entering through the entrance surfaces 384i. Thus, for example, an optical element 2c (a collimator lens) for decreasing the divergence angle may be disposed between the exit surface of the light adjustment unit 2 and the entrance surfaces 384i. For example, each of the entrance surfaces 384i may be provided with a lens function.

The optical element 2c is an element having a light convergence function or a light divergence function.

For example, the reflective surfaces 384r may be formed as mirror surfaces. In this case, the reflective surfaces 384r may be formed as diffusing surfaces. For example, emboss processing or the like may be performed on the reflective surfaces 384r.

This allows the light to travel in the +Z axis direction and also improve the light uniformity which is insufficient inside the light guide member 384.

For example, in the case that the light adjustment unit 2 emits light with high directivity, such as a case of an LD, the uniformity of the light intensity distribution inside the light guide members 384 is insufficient. In this case, some local parts of the light reflected by the reflective surface 384r and then emitted from the light guide unit 380 are bright. In other words, the light emitted from the light guide unit 380 is point-like light.

For example, in a case where emboss processing or the like has been performed on the reflective surface 384r, the reflected light is scattered light. For this reason, the reflected light spreads and travels in the +Z axis direction. Thus the number of the locally bright areas decreases.

The entrance surface 384i of the light guide member 384 may be provided with a diffusing surface. A diffusion element (an optical element 2c) may be disposed at a position of the entrance surface 384i of the light guide member 384.

In this case, the light having high directivity and an angle travels inside of the individual light guide member 384. In other words, the divergence angle of the light having high directivity is increased. Thus the number of times of reflections inside the light guide member 384 is increased. Therefore, the uniformity of the light intensity distribution on the reflective surface 383 is improved.

The reflective surfaces 384r may be simply formed as diffusing surfaces, instead of mirror surfaces. In this case, while more light passes through the reflective surface 384r, the uniformity of the reflected light can be increased.

Reflective films may be formed as the reflective surfaces 384r. In this case, it is necessary to form diffusing reflective surfaces by making these reflective films coarse. By forming the reflective films, it is possible to prevent the light that does not satisfy the total reflection condition from traveling in the +X axis direction.

### (Variation 2)

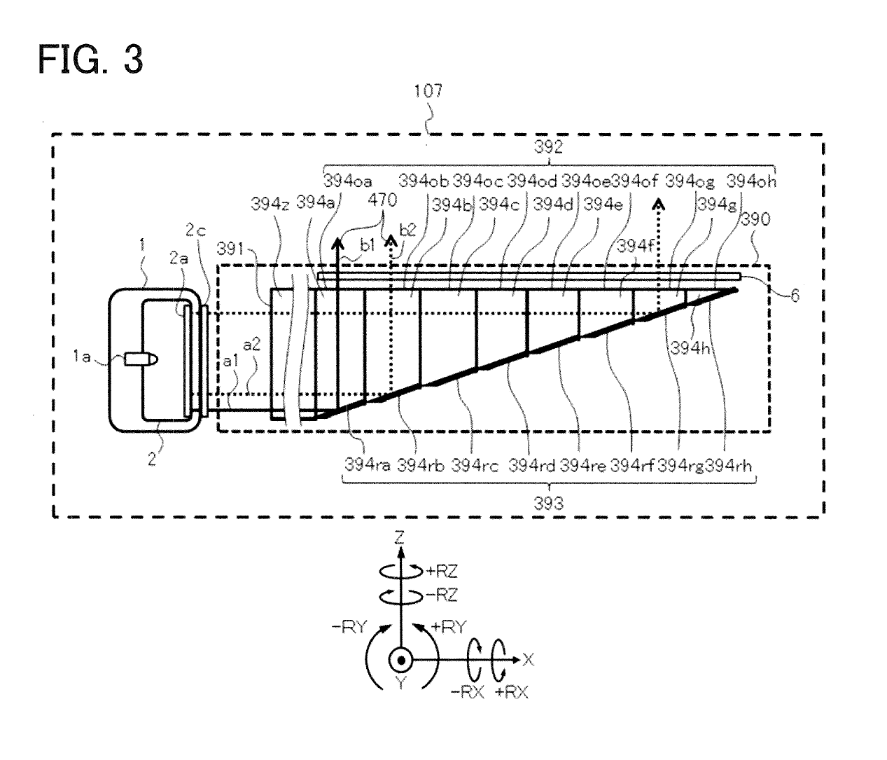

FIG. 3 is a schematic diagram illustrating a lighting apparatus 107 according to variation 2.

A light guide unit 390 includes a plurality of light guide members 394. A set of reflective surfaces 394r of the light guide members 394 forms a reflective surface 393 of the light guide unit 390. A set of exit surfaces 394o of the light guide members 394 forms an entrance surface 392 of the light guide unit 390.

The above-described light guide members 374 and 384 are arranged to guide the light in the X axis direction. On the other hand, the light guide members 394 are arranged to guide the light in the Z axis direction. Variation 2 differs from variation 1 in this respect.

A side surface of a light guide member 394a can be an entrance surface 391 of the light guide unit 390. However, as illustrated in FIG. 3, a light guide member 394z, which does not include a reflective surface 394r, may be disposed on the −X axis direction side of the light guide member 394a. In this case, an end surface on the −X axis direction side of the light guide member 394z is the entrance surface 391 of the light guide unit 390.

By disposing the light guide member 394z, even when an optical function is given to the entrance surface 391, the light guide property of the light guide member 394a is not decreased. The “optical function” includes, for example, a function of diffusing or collecting light or other functions.

The light guide members 394 include the reflective surfaces 394r. Each of the reflective surfaces 394r is located at an end portion on the −Z axis direction side of the light guide member 394. In FIG. 3, each of the reflective surfaces 394r is an end surface on the −Z axis direction side of the light guide member 394.

In the same way as in variation 1, the reflective surfaces 394r may be formed as total reflection surfaces. Alternatively, the reflective surfaces 394r may be formed as mirror surfaces. Alternatively, the reflective surfaces 394r may be famed as diffusing reflective surfaces.

For example, the inclination of the reflective surface 393 may be determined so that the light that enters in parallel to the X axis direction is totally reflected by the reflective surface 393. For example, when one of the reflective surfaces 394r is illuminated with the light, it is preferable to increase the degree of parallelization of the light emitted from a light adjustment unit 2. In other words, by increasing the degree of parallelization of the light emitted from the light adjustment unit 2, one of the reflective surfaces 394r is easily illuminated with the light.

As described above, in a case where the light adjustment unit 2 is configured as a container having an inner surface of a reflective surface and including a liquid crystal shutter 2a, a collimator lens (an optical element 2c) may be disposed at the light emission position. On the other hand, in a case where light with high-directivity is scanned by using a mirror or the like, a collimator lens is not necessarily needed.

In a case where the reflective surfaces 394r are formed as diffusing reflective surfaces, it is preferable that the light scattering level be set to such a level that the light traveling inside of the light guide members 394 satisfies the total reflection condition. If the light scattering level is excessively increased, when reflected light travels inside of the light guide member 394, the total reflection condition is not met, and the light guide property decreases. Thus it is desirable that the light scattering level at the reflective surface 394r be suppressed.

To form diffusing surfaces, for example, emboss processing or the like may be performed on the reflective surfaces 394r. Alternatively, a diffusing reflective sheet may be attached to each of the reflective surfaces 394r, for example.

Alternatively, coating for diffusion and reflection may be applied to each of the reflective surfaces 394r, for example.

In this way, the light that has reached the reflective surface 393 is diffused and reflected. The light diffused and reflected by the reflective surface 393 travels in the +Z axis direction. The diffused and reflected light travels while it is repeatedly reflected inside the light guide member 394. While the light is traveling inside of the light guide member 394, the uniformity of the light intensity distribution is improved.

The light propagating inside the light guide member 394 is reflected by side surfaces of the light guide member 394. In this way, the light is superimposed as it is reflected. Thus the uniformity of the light is improved. In other words, the light guide member 394 receives light and emits light having improved uniformity in light intensity distribution.

The light traveling inside of the light guide member 394 reaches the exit surface 394o. The light which has reached the exit surface 394o is emitted in the +Z axis direction. The light which has propagated inside the light guide member 394 is emitted from the exit surface 394o after its light intensity distribution is made uniform. In this way, although the light has insufficient uniformity in light intensity distribution when the light enters the light guide unit 390, the uniformity is improved. The light having the improved uniformity in light intensity distribution is then emitted from the light guide unit 390 in the +Z axis direction.

Each of the light guide members 394 includes the exit surface 394o. The exit surface 394o is disposed at an end portion on the +Z axis direction side of the light guide member 394. In FIG. 3, the exit surface 394o is an end surface on the +Z axis direction side of the light guide member 394.

For example, the exit surfaces 394o of the light guide members 394 are parallel to the X-Y plane. In FIG. 3, the exit surfaces 394o of the light guide members 394 are positioned on the same plane. In FIG. 3, a set of the exit surfaces 394o of the light guide members 394 forms the exit surface 392 of the light guide unit 390.

Material for the light guide members 394 is glass, resin or the like. Regarding the material of the light guide members, similar material is applicable to the other embodiments or other variations.

In the case of variation 1, if light is diffused and reflected by the reflective surfaces 384r, each of light emission regions on the exit surface 382 widens undesirably. Thus the light overlaps with neighboring light. To suppress this overlapping of the light, it is conceivable that a gap is provided between the reflective surfaces 384r in the X axis direction for example. However, this is not preferable in terms of downsizing of the apparatus.

In the case of variation 2, the light guide member 394 is disposed in such a manner that a longer axis of the light guide member 394 corresponds to the light emission direction (the Z axis direction). Since the light to be emitted from the light guide member 394 is guided by the light guide member 394, it is possible to prevent the light from overlapping on the exit surface 392. Since the light guide member 394 has a function of uniforming the light, light having more uniformed intensity can be emitted.

The shape of the exit surface 392 can be set arbitrarily. In other words, the exit surface 392 can be formed as a diffusing surface. Alternatively, the shape of the exit surface 394o may be formed to be a lens shape. Alternatively, some of the exit surfaces 394o may be formed as lens surfaces, and the other of the exit surfaces 394o may be formed as diffusing surfaces.

In the case of variation 1, the exit surface 382 is formed on a side surface of the light guide member 384. In FIG. 2, the exit surface 382 is the side surface on the +Z axis direction side of the light guide member 384h. In this case, if the shape of the side surface on the +Z axis direction side of the light guide member 384h is changed, there is a possibility of lowering of the light guide property of the light guide member 384h.

In the case of variation 2, the exit surface 392 is formed by a set of the exit surfaces 394o of the light guide members 394. Thus design flexibility in the shape of the exit surface 392 is improved.

For example, by forming each of the exit surfaces 394o to be a lens shape, the divergence angle of the emitted light can be changed. Alternatively, for example, by forming each of the exit surfaces 394o to be an uneven surface (a diffusing surface), the uniformity of the emitted light can be improved.

Fluorescent substance elements may be disposed at the positions of the reflective surfaces 347r, 348r or 349r described above. By disposing fluorescent substance elements at the positions of the reflective surfaces 347r, 348r, 349r, the color of the light emitted from each of the light guide units 370, 380, 390 can be changed. Since each fluorescent substance emits diffused light, uniformity of the light intensity distribution is improved. Thus light having a different color and improved uniformity can be emitted from each of the regions in the exit surface 372, 382, 392.

If fluorescent substance elements are disposed at the positions of the reflective surfaces 347r, 348r, 349r, in the case of the lighting apparatuses 105 and 106, each of the light emission regions widens. In the case of the lighting apparatus 107, there is a possibility of lowering of the light guide property of the light guide members 394.

Alternatively, a fluorescent substance element may be disposed at the positions of the exit surfaces 372, 382, 392. In FIG. 3, the fluorescent substance element is illustrated as an optical element 6. In this case, the widening of the light emission regions in the lighting apparatus 105, 106 is suppressed. In addition, the decrease of the light guide property in the lighting apparatus 107 is suppressed.

Examples of the optical element 6 are a lens array, a diffusion element, a fluorescent substance element and so on.

The light guide units 370, 380, 390 according to embodiment 1 include the plurality of light guide members 374, 384, 394, respectively. Design flexibility can be provided in the shape of the light guide members. In embodiment 1, each of the light guide members 374, 384, 394 is shaped like a cuboidal bar or a cuboidal plate. However, for example, depending on the shape of the vehicle, the shape of each of the light guide members 374, 384, 394 may be changed. In other words, the light guide members 374, 384, 394 may be shaped like a curved bar or a curved plate.

Light is separately guided by the light guide members 374, 384, 394. Thus, by changing the shape of the light guide members 374, 384, 394, the direction of the light emitted from the light guide units 370, 380, 390 can be made different from the direction of the light entering the light guide units 370, 380, 390. This allows the shape of the lighting apparatuses 105, 106, 107 to have design flexibility. For example, so as to fit the shape of installation location such as a vehicle, the lighting apparatuses 105, 106, 107 can be downsized. In other words, the arrangement of the light source unit 1 can be changed, according to conditions for installation location.

### Embodiment 2

In embodiment 1, the light guide units 370, 380, 390 include the plurality of light guide members 374, 384, 394, respectively. Embodiment 2 differs from embodiment 1 in that the number of light guide members is one.

In a lighting apparatus 100 illustrated in FIG. 4, a light guide unit 300 includes a light guide member 304. The light guide unit 300 includes a single light guide member 304. The light guide member 304 includes a plurality of reflective surfaces 303. Embodiment 1 describes an example that the single light guide member 374, 384 or 394 includes the single reflective surface 374r, 384r or 394r respectively. Embodiment 2 differs from embodiment 1 in this respect, too.

The light guide members that appear in embodiment 2 will be described as the light guide member 304.

In embodiment 2, a single light source unit 1 emits light to the single light guide member 304. The plurality of reflective surfaces 303 (optical control surfaces) is selectively illuminated with the light that has entered. This makes it possible to change light-emitting regions 5 on the light guide unit 300.

In addition, by increasing the speed of selecting the reflective surface 303, it is possible to emit light from the entire light guide unit 300. In addition, since only one light guide member 304 is used, the lighting apparatus 100 can be realized with a simple configuration.

FIG. 4 is a schematic diagram illustrating the lighting apparatus 100 according to embodiment 2.

The lighting apparatus 100 includes the light source unit 1 and the light guide unit 300. The light source unit 1 includes a light adjustment unit 2. The light source unit 1 and the light adjustment unit 2 are the same as those of embodiment 1. Thus their detailed description will be omitted.

### (Light Guide Unit 300)

The light guide unit 300 is shaped like a bar or a plate, for example. The light guide unit 300 includes an entrance surface 301. The light guide unit 300 also includes an exit surface 302. The light guide unit 300 includes the light guide member 304. The light guide member 304 includes the reflective surfaces 303. Inside the light guide member 304, the plurality of reflective surfaces 303 is disposed.

The entrance surface 301 receives the light emitted from the light source unit 1. For example, the entrance surface 301 is disposed at an end portion of the light guide unit 300. In FIG. 4, the entrance surface 301 is disposed at an end surface of the light guide member 304. In FIG. 4, the entrance surface 301 is an end surface on the −X axis direction side of the light guide member 304.

Supposing that representative light that has been made incident on the entrance surface 301 is a light beam 4, the light beam 4 travels inside of the light guide unit 300 in the +X axis direction. In FIG. 4, the light beam 4 travels inside of the light guide member 304 in the +X axis direction. The light adjustment unit 2 changes the traveling direction of the light emitted from the light source unit 1, as indicated by dashed lines. Accordingly, the traveling direction of the light beam 4 also changes inside the light guide unit 300.

In other words, the light beam 4 emitted from the light source unit 1 is scanned by the light adjustment unit 2. In FIG. 4, the light beam 4 is scanned in the Z axis direction. The light adjustment unit 2 changes the emission angle of the light beam 4 emitted from the light source unit 1. An emission angle of the light beam 4 emitted from the light source unit 1 is changed by the light adjustment unit 2.

For example, the light guide unit 300 includes a plurality of boundary surfaces 305. Each of the boundary surfaces 305 is formed with an inclination with respect to the traveling direction of the light beam 4. In FIG. 4, the boundary surfaces 305 are inclined with respect to the entrance surface 301 in the clockwise direction.

Each of the boundary surfaces 305 includes the reflective surface 303 that reflects light in a region on a part of the surface, and the other region is formed to transmit light. In other words, each of the boundary surfaces 305 includes the reflective surface 303 that reflects light in a region on a part of the surface. That is, a region which is a part of each of the boundary surfaces 305 includes the reflective surface 303 that reflects light, and the other region of each of the boundary surfaces 305 is formed to transmit light.

Each of the boundary surfaces 305 has a configuration that reflects the light beam 4 so that the light beam 4 travels forward (in the +Z axis direction) relative to the lighting apparatus 100 after it reaches the boundary surface 305. In other words, the light beam 4 is reflected by the reflective surface 303 and travels in the +Z axis direction. The +Z axis direction is a direction of the exit surface 302.

The reflective surface 303 is an optical control surface that changes the direction of the light that has entered the light guide unit 300. The light guide unit 300 includes a plurality of optical control surfaces that changes the traveling direction of the light that has entered the light guide unit 300. The light guide member 304 includes the plurality of optical control surfaces that changes the traveling direction of the light that has entered the light guide member 304.

Each of the boundary surfaces 305 does not need to extend to divide the light guide unit 300 as if it is a cross section of the light guide unit 300. For example, it may be disposed in a part inside the light guide component 300. Alternatively, the boundary surface 305 may be formed by only the reflective surface 303.

In other words, each of the boundary surfaces 305 is not limited to a surface that divides the light guide member 304. For example, each of the boundary surfaces 305 may be disposed in a part inside the light guide unit 300. In other words, each of the boundary surfaces 305 is disposed in a part of a region through which the light traveling inside of the light guide member 304 passes.

Alternatively, it may be configured that the boundary surface 305 includes only the reflective surface 303. It means that the reflective surface 303 may be formed on the entire surface of the boundary surface 305 which is disposed in a part inside the light guide member 304.

It is not necessary for the reflective surfaces 303 to extend across the light guide unit 300 in the Y axis direction from an upper surface end to a lower surface end. Each of the reflective surfaces 303 may be disposed only in a part of the light guide unit 300. In other words, it is not necessary for the reflective surfaces 303 to extend from one of the surface ends to the other surface end in a direction (the Y axis direction) parallel to the exit surface 302 and perpendicular to the light beam 4. The Y axis direction is the depth direction in FIG. 4.

In this embodiment, the light guide member 304 is manufactured by bonding a plurality of parts of light guide member 304 divided by the boundary surfaces 305. However, for example, the light guide member 304 may be manufactured by using a method of performing insert molding while members with reflective surfaces are positioned. In this case, no boundary surfaces 305 are formed.

For example, the reflective surfaces 303 are arranged so that a reflective surface 303 disposed farther in the +X axis direction inside the light guide unit 300 is disposed farther in the Z axis direction. By this configuration, the direction in which the light traveling direction changed by the light adjustment unit 2 moves can be regarded as a direction of translational movement in the +Z axis direction.

The plurality of reflective surfaces 303 is disposed in the direction (+X axis direction) in which the light beam 4 travels inside of the light guide member 304. The plurality of reflective surfaces 303 is arranged in the direction in which the light beam 4 travels inside of the light guide member 304.

A reflective surface 303a disposed closest to the entrance surface 301 is disposed in a position farthest from the exit surface 302 in the direction (+Z axis direction) in which the light beam 4 is emitted. A reflective surface 303b disposed on the +X axis direction side with respect to the reflective surface 303a is disposed on the +Z axis direction side with respect to the reflective surface 303a.

In other words, the reflective surfaces 303 are disposed in such a manner that a reflective surface 303 farther from the entrance surface 301 is disposed closer to the exit surface 302. A reflective surface 303 farther from the entrance surface 301 is disposed closer to the exit surface 302 than a reflective surface 303 closer to the entrance surface 301.

In this way, the light beam 4 can reach a selected one of the reflective surfaces 303 without being blocked by any of the other reflective surfaces 303. Then, the light beam 4 reflected by the selected one of the reflective surfaces 303 can reach the exit surface 302 without being blocked by any of the other reflective surfaces 303.

In addition, by adjusting the inclination angles of the reflective surfaces 303, the light beams 4 reflected by the individual reflective surfaces 303 can be made parallel to each other. Therefore, as the light beams 4, parallel light beams can be emitted from the exit surface 302.

The light guide direction of the light beam 4 guided inside the light guide member 304 is selectively changed by the light adjustment unit 2. Thus, for example, when the light beam 4 that has entered the light guide unit 300 from the light source unit 1 is caused to travel a path a1 by the light adjustment unit 2, the light beam 4 is reflected by the reflective surface 303a, travels a path b1, and is emitted forward (in the +Z axis direction) relative to the lighting apparatus 100.

Next, for example, the light beam 4 is scanned in the +Z axis direction. When the light beam 4 that has entered the light guide unit 300 from the light source unit 1 is caused to travel a path a2 by the light adjustment unit 2, the light beam 4 is reflected by the reflective surface 303b, travels a path b2, and is emitted forward (in the +Z axis direction) relative to the lighting apparatus 100.

In the above cases, a light-emitting region 5a on the exit surface 302 of the light guide unit 300 through which the light beam 4 that has traveled the paths a1 and b1 is emitted is different from a light-emitting region 5b on the exit surface 302 of the light guide unit 300 through which the light beam 4 that has traveled the paths a2 and b2 is emitted.

In addition, when the light adjustment unit 2 changes the direction of the light beam 4 that enters the light guide unit 300 from the light source unit 1, the direction of the light beam 4 traveling inside of the light guide unit 300 also changes. According to this, the boundary surface 305 (reflective surface 303) reflecting the light beam 4 is also changed.

The surface that reflects the light changes in order of a reflective surface 303c, a reflective surface 303d, and so on, and the light-emitting region 5 on the light guide unit 300 accordingly changes.

The selected reflective surface is changed, for example, from the reflective surface 303c to the reflective surface 303d by the scanning of the light beam 4. Along with this change of the reflective surface 303, the light-emitting region 5 on the exit surface 302 from which the light beam 4 is emitted is also changed.

The configurations of the boundary surfaces 305 are not limited to the above configurations. A mirror, a half mirror, a dichroic mirror, or a polarization mirror may be used for the boundary surfaces 305.

In other words, the light adjustment unit 2 can selectively change the direction of the light (the light beam 4) that enters the light guide unit 300 from the light source unit 1. In addition, depending on the direction, the light-emitting region 5 on the exit surface 302 of the light guide unit 300 can selectively be changed.

In other words, the light adjustment unit 2 emits the light beam 4 that enters the light guide unit 300 selectively to the optical control surface (the reflective surface 303). In addition, the light adjustment unit 2 makes it possible to dynamically emit the light which is emitted from the light source unit 1, through the region (the light-emitting region 5) on the exit surface 302 of the light guide unit 300.

In addition, by controlling timing of light emission of the light source unit 1 or the switching speed or switching pattern of the direction of the light that enters the light guide unit 300 from the light source unit 1, it is possible to emit light from only an arbitrary region (the light-emitting region 5) on the exit surface 302 of the light guide unit 300.

The light adjustment unit 2 controls timing of light emission of the light source unit 1, the scanning speed or scanning pattern of the light beam 4 emitted from the light source unit 1, and so on. By these control operations in the light adjustment unit 2, it is possible to emit light from a selected one or more of the light-emitting regions 5 on the exit surface 302 of the light guide unit 300.

It is also possible to dynamically emit light from the arbitrary regions (light-emitting regions 5) and to emit light from the entire light guide unit 300. In other words, by increasing the scanning speed of the light beam 4, it is also possible to emit light from all of the light-emitting regions 5 of the light guide unit 300. In a case where the light-emitting regions 5 are disposed all over the entire exit surface 302, by increasing the scanning speed of the light beam 4, it is possible to emit light from the entire exit surface 302 of the light guide unit 300.

The way in which the light beam 4 travels in the light guide unit 300 is not limited to that described above. The light beam 4 may reach the boundary surface 305 after internal reflection of the light beam 4 inside the light guide unit 300.

That is, after entering through the entrance surface 301 and then being reflected by a side surface of the light guide member 300, the light beam 4 can be made to reach the reflective surface 303. This allows the light beam 4 to reach one of the reflective surfaces 303 which is located in a position where the light is blocked by another one of the reflective surfaces 303. Here, the exit surface 302 is given as the side surface by which the light beam 4 is reflected.

Dynamically emitting light from an arbitrary region means emitting light from an arbitrary region by changing the arbitrary region temporally and selectively. In addition, it is possible to emit light from the entire light guide unit by quickly changing the direction of the incident light.

In addition, for example, in a case where a laser diode (LD) is used in the light source unit 1, fluorescent substance may be provided in the front part (on the +Z axis direction side) of the lighting apparatus 100. In other words, by using excitation light as the light emitted from the light source unit 1, it is possible to make the fluorescent substance emit light. Instead of an LD, an LED or the like may be used for the excitation light.

The “fluorescent substance” is used as the term having the same meaning as the fluorescent substance element described above. In FIG. 4, the fluorescent substance is illustrated as optical elements 6a and 6b. The optical element 6a is disposed at the entrance surface 301. The optical element 6b is disposed at the exit surface 302.

In addition, the fluorescent substance may also be disposed at the entrance surface 301 or the reflective surface 303 constituting the boundary surface 305. For example, the fluorescent substance is embedded in the light guide member 304. Alternatively, for example, the fluorescent substance is disposed to be in contact with a surface of the light guide member 304. Regarding the configuration relating to a place where the fluorescent material is provided, similar configuration is applicable to the following variations 3 to 5. Regarding the configuration relating to a place where the fluorescent material is provided, similar configuration is applicable to other examples.

Fluorescent substance may be disposed at a position of the entrance surface 301, the exit surface 302, or the reflective surface 303 of the light guide unit 300. In a case where the fluorescent substance is disposed at a position of the reflective surface 303, the fluorescent substance may be disposed on the side of the reflective surface 303 on which the light beam 4 is incident, and the reflective surface 303 may be disposed on the back side of the fluorescent substance. With this configuration, the fluorescence emitted from the back side of the fluorescent substance can be reflected toward the exit surface 302.

The light emitted from the fluorescent substance is diffused light. Thus, to reduce the region on the exit surface 302 from which light is emitted, it is desirable that the fluorescent substance be disposed at the exit surface 302.

In the light guide unit 300, it is sufficient to form the reflective surfaces 303 that reflect the light beam 4 so that the light beam 4 travels forward relative to the lighting apparatus 100 (in the +Z axis direction). Thus the shape of the light guide unit 300 is not limited to a cuboid shape as illustrated in FIG. 1. For example, the light guide unit 300 may have a curved shape. Regarding the configuration about the shape of the light guide unit 300, similar configuration is applicable to the following variations 3 to 5. Regarding the configuration about the shape of the light guide unit 300, similar configuration is applicable to other examples.

In addition, it is not necessary to form the shape of the entrance surface 301, the boundary surface 305, or the reflective surface 303 to be a flat surface. The entrance surface 301, the boundary surface 305, or the reflective surface 303 may be formed as a free-form surface, for example. The light guide unit 300 having this configuration is capable of emitting illumination light having a higher degree of freedom. In other words, by using the light guide member 304, design flexibility in the shape of the light-emitting surface (exit surface 302) can be obtained.

Regarding the configuration about the shape of the entrance surface, the boundary surfaces, or the reflective surfaces, similar configuration is applicable to the following variations 3 to 5. Regarding the configuration about the shape of the entrance surface, the boundary surfaces, or the reflective surfaces, similar configuration is applicable to other examples.

The surface on the +Z axis direction side (the exit surface 302) of the light guide unit 300 through which the light beam 4 is emitted may be formed as a free-form surface. The exit surface 302 may be formed to have a lens shape having a lens effect. Alternatively, for example, the exit surface 302 may be formed to have a prism surface shape.

For example, the emitted light may be controlled by forming the light-emitting region 5 on the exit surface 302, which corresponds to a reflective surface 303, to be a lens shape.

Regarding the configuration about the surface of the light guide unit 300 through which the light beam 4 is emitted (the exit surface 302), similar configuration is applicable to the following variations 1 to 5. Regarding the configuration about the surface of the light guide unit 300 through which the light beam 4 is emitted (the exit surface 302), similar configuration is applicable to other examples.

In addition, it is not necessary to dispose the reflective surfaces 303 discretely. The reflective surfaces 303 may be disposed so as to neighbor each other on the same boundary surface 305 of the light guide unit 300. Alternatively, the reflective surfaces 303 may be disposed in such a manner that neighboring reflective surfaces appear to be adjacent to each other when seen from the +Z axis direction but in fact they are discretely disposed on the different boundary surfaces 305.

A position on the X axis of an end portion on the +X axis direction side of one of the reflective surfaces 303 can agree with a position on the X axis of an end portion on the −X axis direction side of another one of the reflective surface 303, which is adjacent to the one of the reflective surfaces 303 and disposed on the +X axis direction side. That is, for example, a position on the X axis of an end portion on the +X axis direction side of the reflective surface 303a can agree with a position on the X axis of an end portion on the −X axis direction side of the reflective surface 303b.

In this case, when seen from the +Z axis direction side, the reflective surfaces 303 appear to be disposed with no gap between them.

In addition, a position on the Z axis of an end portion on the +X axis direction side of one of the reflective surfaces 303 can agree with a position on the Z axis of an end portion on the −X axis direction side of another one of the reflective surfaces 303, which is adjacent to the one of the reflective surfaces 303 and disposed on the +X axis direction side. That is, for example, a position on the Z axis of an end portion on the +X axis direction side of the reflective surfaces 303a can agree with a position on the Z axis of an end portion on the −X axis direction side of the reflective surfaces 303b.

In this case, when seen from the −X axis direction side, the reflective surfaces 303 appear to be disposed with no gap between them.

Regarding the configuration about the arrangement of the reflective surfaces, similar configuration is applicable to the following variations 3 to 5. Regarding the configuration about the arrangement of the reflective surfaces, similar configuration is applicable to other examples.

The reflective surface 303 may be formed by using a mirror, a half mirror, a dichroic mirror, a polarization mirror or the like. However, the structure of the reflective surface 303 is not limited to these. For example, the reflective surface 303 may be a diffusing surface. Regarding the configuration of the reflective surfaces, similar configuration is applicable to the following variations 3 to 5. Regarding the configuration of the reflective surfaces, similar configuration is applicable to other examples.

### (Variation 3)

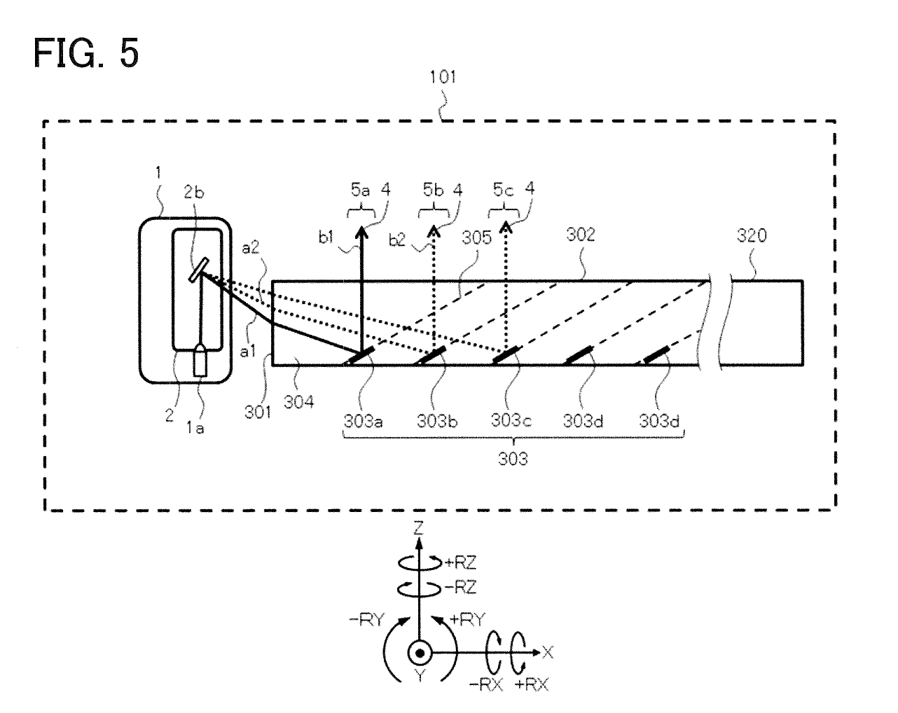

FIG. 5 is a schematic diagram illustrating a lighting apparatus 101 according to variation 3. The lighting apparatus 101 includes a light source unit 1 and a light guide unit 320. The light source unit 1 includes a light adjustment unit 2. The configurations of the light source unit 1 and the light adjustment unit 2 are the same as those of the lighting apparatus 100.

The light guide unit 320 includes a light guide member 304. The light guide unit 320 includes an entrance surface 301 and an exit surface 302. In FIG. 5, the entrance surface 301 and the exit surface 302 are formed as surfaces of the light guide member 304. The entrance surface 301 is the surface on the −X axis direction side of the light guide member 304. The exit surface 302 is the surface on the +Z axis direction side of the light guide member 304.

The light guide member 304 has boundary surfaces 305 and reflective surfaces 303. However, their configurations are different from those of the lighting apparatus 100.

The reflective surfaces 303 differ from those of the light guide unit 300 in that the reflective surfaces 303 are arranged inside the light guide member 304 so that even when their positions in the X axis direction are different, their positions in the Z axis direction are the same.

The plurality of reflective surfaces 303 is disposed at the same distance from the exit surface 302.

In the light guide unit 320, the positions of the reflective surfaces 303 in the Z axis direction are the same. In FIG. 5, all of the reflective surfaces 303 are disposed on a surface facing the exit surface 302. The position in the Z-axis direction of the reflective surfaces 303 is not limited to a position on the surface facing the exit surface 302. In other respects, the configuration of the light guide unit 320 is the same as that of the light guide unit 300.

In the configuration of the light guide unit 320, when it is seen from the side of the entrance surface 301, light to one reflective surface 303 tends to be blocked by another reflective surface 303 located closer to the entrance surface 301 than the one reflective surface. For this reason, by making the region on the entrance surface 301 where the light beam 4 is incident closer to the exit surface 302 than that in the case of the lighting apparatus 100, it is possible to irradiate all the reflective surfaces 303 with the light. In other words, by increasing the angle at which the light beam 4 is incident on the entrance surface 301, it is possible to irradiate all the reflective surfaces 303 with the light.

It is sufficient that the reflective surface 303 can reflect the light beam 4 so that the light beam 4 travels forward (in the +Z axis direction) respective to the lighting apparatus 100 or 101. The positions of the boundary surfaces 305 and the reflective surfaces 303 are not limited to those of the above configurations.

In addition, it is not necessary to dispose the reflective surfaces 303 discretely. The reflective surfaces 303 may be disposed to neighbor each other on the same boundary surface 305 of the light guide unit 300. Alternatively, the reflective surfaces 303 may be disposed in such a manner that neighboring ones of the reflective surfaces appear to be adjacent to each other when seen from the +Z axis direction, but the actual reflective surfaces are discretely disposed on the different boundary surfaces 305.

The position on the X axis of an end portion on the +X axis direction side of one of the reflective surfaces 303 may be the same as the position on the X axis of an end portion on the −X axis direction side of another one of the reflective surfaces 303 that is adjacent to the one of the reflective surfaces 303 in the +X axis direction. That is, for example, the position on the X axis of the end portion on the +X axis direction side of the reflective surface 303a may be the same as the position on the X axis of the end portion on the −X axis direction side of the reflective surface 303b.

### (Variation 4)

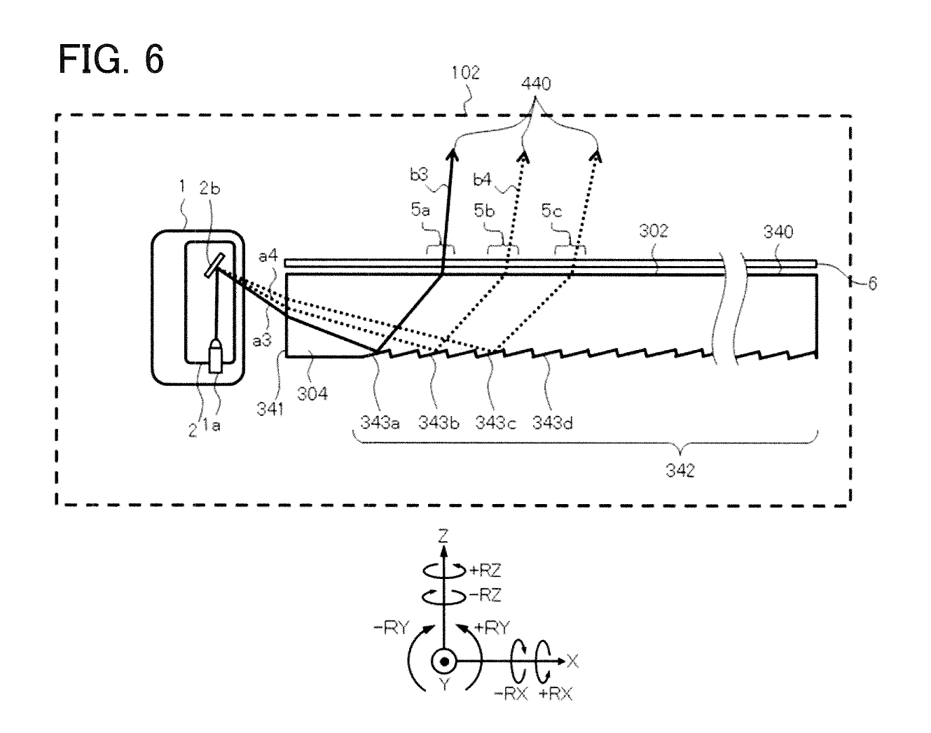

FIG. 6 is a schematic diagram illustrating a lighting apparatus 102 according to variation 4.

The lighting apparatus 102 includes a light source unit 1 and a light guide unit 340. The light source unit 1 includes a light adjustment unit 2. The configurations of the light source unit 1 and the light adjustment unit 2 are the same as those of the lighting apparatus 100. The light guide unit 340 includes a light guide member 304.

The light guide unit 340 includes an entrance surface 341 on which the light emitted from the light source unit 1 is made incident. The entrance surface 341 is disposed at an end portion on the −X axis direction side of the light guide unit 340. In FIG. 6, the entrance surface 341 is disposed on an end surface on the −X axis direction side of the light guide member 304.

Supposing that representative light that has been made incident on the entrance surface 341 is a light beam 440, the light beam 440 travels inside of the light guide member 304 toward the +X axis direction side. When the light adjustment unit 2 changes the direction of the light emitted from the light source unit 1, the traveling direction of the light beam 440 inside the light guide unit 340 accordingly changes.

The light beam 440 emitted from the light source unit 1 is scanned by the light adjustment unit 2. In FIG. 6, the light beam 440 is scanned in the Z axis direction.

The light guide unit 340 has a prism surface 342 on the outside thereof. The prism surface 342 is an optical surface that directs the traveling direction of the light beam 440 toward the front of the lighting apparatus 102 (the +Z axis direction). For example, the prism surface 342 totally reflects light. The prism surface is an optical control surface that changes the direction of the light that has entered the light guide member 304.

The prism surface 342 includes reflective surfaces 343 that reflect light. A plurality of reflective surfaces 343 is provided in the prism surface 342.

The prism surface 342 is formed on a side surface of the light guide member 304. For example, the prism surface 342 is formed as a surface facing an exit surface 302.

The prism surface 342 includes inclined surfaces each of which is a surface rotated in the −RY direction from a plane of the entrance surface 341. These inclined surfaces correspond to the reflective surfaces 303 described above. Hereinafter, these inclined surfaces will be described as the reflective surfaces 343.

The light adjustment unit 2 selectively changes the direction of the light beam 440 guided inside the light guide member 304. Thus, for example, when the light beam 440 that has entered the light guide unit 340 from the light source unit 1 is caused to travel a path a3 by the light adjustment unit 2, the light beam 440 is totally reflected by a reflective surface 343a, travels a path b3, and is emitted forward (in the +Z axis direction) relative to the lighting apparatus 102.

The light beam 440 is scanned by the light adjustment unit 2. The light adjustment unit 2 irradiates a selected one of the reflective surfaces 343 with the light beam 440. That is, the light adjustment unit 2 selectively irradiates the reflective surfaces 343 with the light beam 440.

The light beam 440 is totally reflected by the reflective surface 343. The totally reflected light beam 440 travels toward the exit surface 302. The totally reflected light beam 440 is then emitted in the +Z axis direction from the exit surface 302.

Next, for example, when the light beam 4 that has entered the light guide unit 340 from the light source unit 1 is caused to travel a path a4 by the light adjustment unit 2, the light beam 440 is totally reflected by a reflective surface 343b, travels a path b4, and is emitted forward (in the +Z axis direction) from the lighting apparatus 340.

In this case, a light-emitting region 5a on the light guide unit 340 obtained when the light beam 440 travels the paths a3 and b3 is different from a light-emitting region 5b on the light guide unit 340 obtained when the light beam 440 travels the paths a4 and b4.

According to scanning by the light adjustment unit 2, the light beam 440 travels different paths. For example, when the light beam 440 travels the path a3, the light beam 440 is reflected by the reflective surface 343a. Then, the light beam 440 travels the path b3 and is emitted from the exit surface 302. On the other hand, when the light beam 440 travels the path a4, the light beam 440 is reflected by the reflective surface 343b. Then, the light beam 440 travels the path b4 and is emitted from the exit surface 302.

The position (the light-emitting region 5a) on the exit surface 302 from which the light beam 440 that has traveled the paths a3 and b3 is emitted is different from the position (the light-emitting region 5b) on the exit surface 302 from which the light beam 440 that has traveled the paths a4 and b4 is emitted.

The position (the light-emitting region 5a) on the exit surface 302 from which the light beam 440 that has traveled the paths a3 and b3 is located on the −X axis direction side compared to the position (the light-emitting region 5b) on the exit surface 302 from which the light beam 440 that has traveled the paths a4 and b4 is emitted.

In addition, when the light adjustment unit 2 changes the direction of the light that enters the light guide unit 340 from the light source unit 1, the direction of the light beam 440 traveling inside of the light guide unit 340 changes. According to this, the prism surface 342 reflecting the light beam 440 is also changed, the totally reflection surface 343 changes in order of a reflective surface 343c, a reflective surface 343d, and so on, and the light-emitting region on the light guide unit 340 accordingly changes.

The selected reflective surface 343 is changed, for example, from the reflective surface 343c to the reflective surface 343d by the scanning of the light beam 440. Along with this change of the reflective surface 343, the light-emitting region 5 on the exit surface 302 from which the light beam 440 is emitted is also changed.

In other words, the light adjustment unit 2 can selectively change the direction of the light (the light beam 440) that enters the light guide unit 340 from the light source unit 1. In addition, depending on the direction, the light-emitting region 5 on the exit surface 302 of the light guide unit 340 can selectively be changed.

In other words, the light adjustment unit 2 emits the light beam 440 that enters the light guide unit 340 selectively to an optical control surface (the reflective surface 343). Thus the light adjustment unit 2 can make a light-emitting region 5 on the exit surface 302 of the light guide unit 340 dynamically emit the light which has been emitted from the light source unit 1.

In addition, by controlling timing of light emission of the light source unit 1 or the switching speed or switching pattern of the direction of the light that enters the light guide unit 340 from the light source unit 1, it is possible to emit light from only an arbitrary region on the exit surface 302 of the light guide unit 340.

The light adjustment unit 2 controls timing of light emission of the light source unit 1 or the scanning speed or scanning pattern of the light beam 440 emitted from the light source unit 1, and so on. By these control operations in the light adjustment unit 2, it is possible to emit light from a selected one or more regions (a light-emitting region 5) on the exit surface 302 of the light guide unit 340.

It is also possible to dynamically emit light from the target arbitrary region (light-emitting region 5) and emit light from the entire light guide unit 340. In other words, by increasing the scanning speed of the light beam 440, it is possible to emit light from the entire light-emitting surface 320 of the light guide unit 340.

The way in which the light beam 440 travels in the light guide unit 340 is not limited to that described above. The light beam 440 may reach the prism surface 342 after internal reflection of the light beam 440 inside the light guide unit 340.

That is, it is possible to make the light beam 440 entering through the entrance surface 341 reflected by the side surface of the light guide member 340 and then reach the prism surface 342. Thus, the light beam 440 can reach one of the reflective surfaces 343 located in a position where the light from the entrance surface 301 is blocked by another one of the reflective surfaces 343. Examples of the side surface that reflects the light beam 440 include the exit surface 302.

In addition, for example, in a case where a laser diode (LD) is used in the light source unit 1, fluorescent substance may be provided in the front part (on the +Z axis direction side) of the lighting apparatus 102. In other words, by using excitation light as the light emitted from the light source unit 1, it is possible to make the fluorescent substance emit light. Instead of an LD, an LED or the like may be used for the excitation light. In FIG. 6, an optical element 6 is indicated as the fluorescent substance.

In addition, in the same way as the above example, the reflective surfaces 343 forming the prism surface 342 may be provided with fluorescent substance.

In the light guide unit 340, it is sufficient to form the reflective surfaces 343 that reflect the light beam 440 so that the light beam 440 travels forward (in the +Z axis direction) relative to the lighting apparatus 102. The shape of the light guide unit 340 is not limited to this. For example, the light guide unit 340 may have a curved shape.

In addition, it is not necessary to form the shape of the entrance surface 341, the prism surface 342, or the reflective surface 343 to be a flat surface. The entrance surface 341, the prism surface 342, or the reflective surface 343 may be formed as a free-form surface, for example. In this way, illumination light with a higher degree of freedom can be obtained. In other words, by using the light guide member 304, design flexibility in the shape of the light-emitting surface (exit surface 302) can be obtained.

The surface on the +Z axis direction side (the exit surface 302) of the light guide unit 340 through which the light beam 440 is emitted may be formed as a free-form surface. The exit surface 302 may be formed to have a lens shape having a lens effect. Alternatively, for example, the exit surface 302 may be formed to have a prism surface shape. However, as described above, in a case where the light beam 440 is once reflected by the exit surface 302 and then is made to reach the reflective surface 343, its design flexibility is restricted.

The prism surface 342 has an optical surface shape that extends in the +X axis direction. However, the shape of the prism surface 342 is not limited to this. For example, the reflective surfaces 343 may be shaped in such a manner that a reflective surface 343 disposed farther in the +X axis direction is disposed farther in the +Z axis direction. By this configuration, the direction in which the light traveling direction changed by the drive device 2 moves can be regarded as a direction of translational movement in the +Z axis direction.

In other words, the reflective surfaces 343 may be disposed in such a manner that a reflective surface 343 farther from the entrance surface 341 is disposed closer to the exit surface 302.

In this way, the light beam 440 can reach a selected one of the reflective surfaces 343 without being blocked by any of the other reflective surfaces 343. Then, the light beam 440 reflected by the selected one of the reflective surfaces 343 can reach the exit surface 302 without being blocked by any of the other reflective surfaces 343.

In addition, by adjusting the inclination angles of the reflective surfaces 343, the light beams 440 reflected by the individual reflective surfaces 343 can be made parallel to each other. Therefore, as the light beams 4440, parallel light beams can be emitted from the exit surface 302.

The number of the light sources is not limited to one. For example, the light source unit 1 may include a plurality of light sources of different colors. Furthermore, the color of the illumination light emitted from the light guide unit 340 can be set freely. In addition, the lighting apparatus 102 may include a plurality of light adjustment units 2 in accordance with the number of the light sources. Light can be emitted in an arbitrary color or from an arbitrary region on the exit surface 302 of the light guide unit 300. Next, examples relating to these will be described as variations 5 and 6.

### (Variation 5)

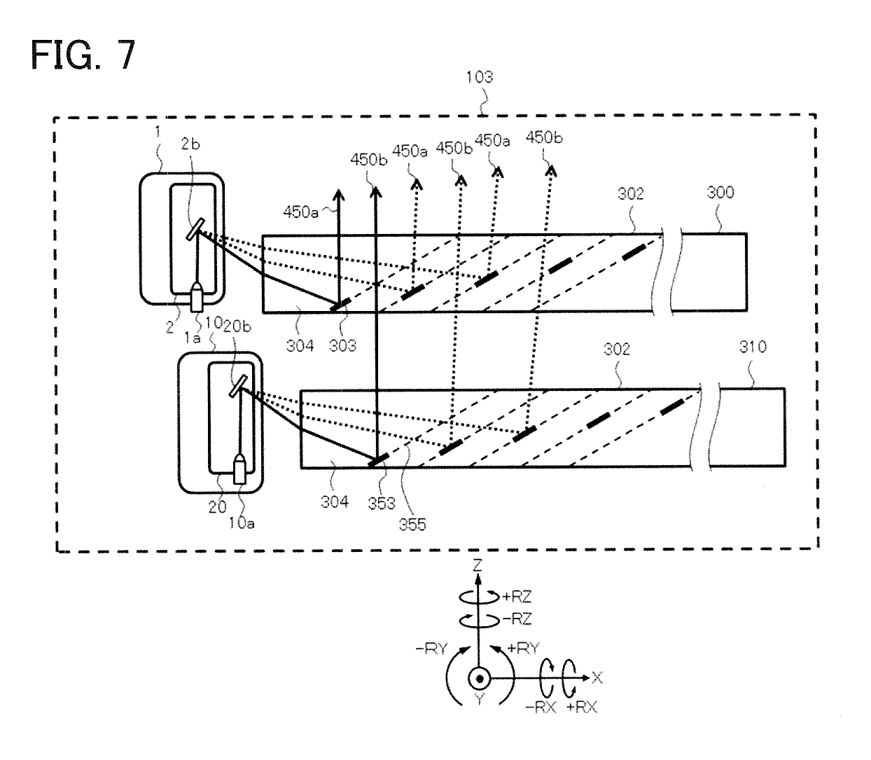

FIG. 7 is a schematic diagram illustrating a lighting apparatus 103 according to variation 5.

The lighting apparatus 103 includes light source units 1 and 10 and light guide units 300 and 310. The light source units 1 and 10 include light adjustment units 2 and 20, respectively. The configurations of the light source units 1 and 10, the light adjustment units 2 and 20, and the light guide units 300 and 310 are the same as those in the lighting apparatus 100.

The light guide unit 310 includes a light guide member 304. The light guide member 304 of the light guide unit 310 includes a plurality of reflective surfaces 353 and a plurality of boundary surfaces 355.

The configuration in which the light is emitted from the light source units 1 and 10 travels inside of the light guide units 300 and 310 and is emitted from the front portion (+Z axis surface side) of the lighting apparatus 103 is the same as that of the lighting apparatus 100.

The light emitted from the light source units 1 and 10 travels inside of the light guide units 300 and 310. The light that has traveled inside of the light guide units 300 and 310 is reflected by reflective surfaces 303 and 353, respectively. Then, the light reflected by the reflective surfaces 303 and 353 is emitted forward (in the +Z axis direction) relative to the lighting apparatus 103. These operations are the same as those in the lighting apparatus 100.

For example, the lighting apparatus 103 can be configured so that in a case where the reflective surfaces 303 are disposed discretely, the light emitted from the light guide unit 310 travels between reflective surfaces 303 disposed in the light guide unit 300. In this respect, the lighting apparatus 103 is different from the lighting apparatus 100.

For example, the reflective surfaces 303 of the light guide unit 300 are discretely disposed in the X axis direction. Thus there is a gap between one reflective surface 303 and another reflective surface 303 in the X axis direction. A light beam 450 emitted from the light guide unit 310 passes through the gap between reflective surfaces 303 of the light guide unit 300 and is then emitted from the lighting apparatus 103.

This configuration provides an advantageous effect that the resolution of the light emitted from the light guide unit 300 increases, and the light can be emitted from divided smaller regions forward (in the +Z axis direction) relative to the lighting apparatus 103.

For example, there are cases in which the reflective surfaces 303 cannot be disposed in such a manner that no gap exists between reflective surfaces 303 in the X axis direction. In such cases, the regions (the light-emitting regions 5) of the lighting apparatus 103, from which the light is emitted, are provided discretely.

Since the plurality of light guide units 300 and 310 is provided, the regions (the light-emitting regions 5) of the lighting apparatus 103, from which the light is emitted and which are provided discretely, can be improved. In other words, the gap between the regions (the light-emitting regions 5) of the lighting apparatus 103, from which the light is emitted, can be narrowed.

In a case where the lighting apparatus 103 is constructed in such a manner that the color of the light emitted from the light guide unit 310 is different from the color of the light emitted from the light guide unit 300, the color of the light emitted from the light guide unit 300 can dynamically be changed.

Since the plurality of light source units 1 and 10 is provided, each of the light source units 1 and 10 can emit a different color of light. Thus it is possible to achieve dynamic light emissions of different colors.

As illustrated in FIG. 7, it is possible to make neighboring light emissions of different colors. For example, the color of a light beam 450a is different from the color of a light beam 450b. In this case, by making neighboring light emissions of different colors simultaneously, the light of the different colors can be mixed. The color of the emitted light can be made different from the colors of the light emitted from the light sources 1a and 10a. In other words, the color of the light emitted from the light source 1a and the color of the light emitted from the light source 10a can be mixed.

The different colors of the light emitted from the light guide units 300 and 310 can be achieved, for example, by providing the light source units 1 and 10 with light sources that emit different colors of light.

### (Variation 6)

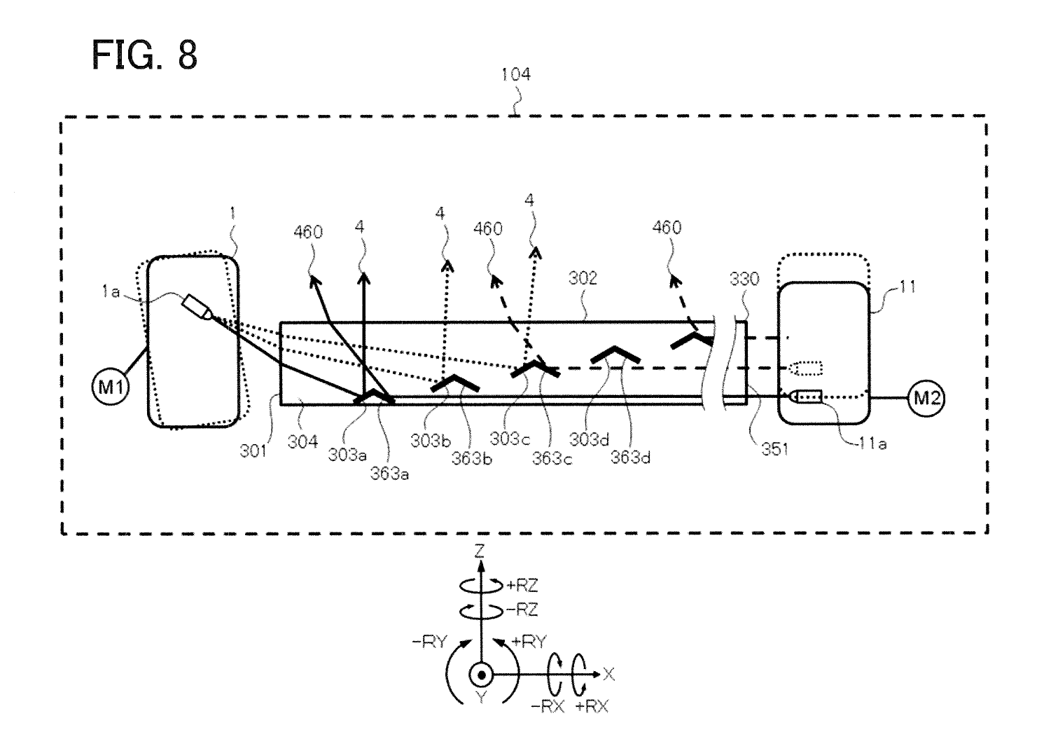

FIG. 8 is a schematic diagram illustrating a lighting apparatus 104 according to variation 6.

The lighting apparatus 104 illustrated in FIG. 8 is constructed by providing the lighting apparatus 100 illustrated in FIG. 4 with two light source units. Light is incident on two portions of a light guide unit 300.

The lighting apparatus 104 includes light source units 1 and 11 and a light guide unit 330. The light source units 1 and 11 include light adjustment units 2 and 21 respectively.

The light source units 1 and 11 do not include the light adjustment unit 2.

For example, the entire light source unit 1 is rotated by a drive device M1 around the Y axis. For example, the drive device M1 is a motor or the like. For example, a rotary motor may be used as the motor. Furthermore, for example, a motor that motions in a linear manner may be used as the motor, and the motion may be converted into rotary motion. By means of this, a light beam 4 whose traveling direction has been changed enters the light guide unit 330 through a different position on an entrance surface 301.

For example, the light source unit 11 is moved by a drive device M2 in the Z axis direction. The light source unit 11 translationally moves. In a case where points of a rigid body or the like move in the same direction in a parallel manner, this movement is called “translational movement”.

For example, the drive device M2 is a motor or the like. For example, a motor that motions in a linear manner may be used as the motor. For example, a rotary motor may be used as the motor, and the motion may be converted into linear motion. By means of this, the light whose emission position has been changed enters the light guide unit 330 through a different position on an entrance surface 351.

The drive devices M1 and M2 have the functions of the above-described light adjustment unit 2. In other words, the drive devices M1 and M2 correspond to the above-described light adjustment unit 2.

The light guide unit 330 includes a light guide member 304.

The light adjustment unit 21 differs from the light adjustment unit 2 in that the light adjustment unit 21 moves translationally the light emitted from the light source unit 1 in the Z axis direction.

The light guide unit 330 differs from the light guide unit 300 in that the light guide unit 330 includes, in addition to the configuration of the light guide unit 300, a plurality of reflective surfaces 363 and the entrance surface 351.

As illustrated in FIG. 8, the light adjustment unit 2 scans the light beam 4. In other words, by changing the traveling direction of the light beam 4 emitted from a single region, the light adjustment unit 2 selects a reflective surface 303. For example, the single region is a mirror surface of a scanning mirror 2b.

On the other hand, the light adjustment unit 21 changes the region through which a light beam 460 is emitted. For example, the region through which the light beam 460 is emitted is an exit surface of a liquid crystal shutter 21a. In FIG. 8, the region through which the light beam 460 is emitted is changed in the Z axis direction.

In addition, in FIG. 8, the light beam 460 emitted from the light adjustment unit 21 is parallel to the X axis. In view of the relationship with the reflective surfaces 363, the light beam 460 emitted from the light adjustment unit 21 does not necessarily need to be parallel to the X axis.

The light (the light beam 460) emitted from the light source unit 11 enters the entrance surface 351 of the light guide unit 330 via the light adjustment unit 21 in the direction (the −X axis direction) opposite to the direction (the +X axis direction) in which the light is emitted from the light source unit 1.

In FIG. 8, the light beam 4 is emitted from the light source unit 1 in the +X axis direction. On the other hand, the light beam 460 is emitted from the light source unit 11 in the −X axis direction. In other words, the light beam 4 and the light beam 460 are emitted from the light source units 1 and 11 in the opposed directions.

The light beam 460 then enters the light guide member 304 of the light guide unit 330 through the entrance surface 351. The entrance surface 301 is disposed at the end portion on the −X axis direction side of the light guide unit 330. The entrance surface 351 is disposed at the end portion on the +X axis direction side of the light guide unit 330. In FIG. 8, the entrance surface 301 is an end surface on the +Z axis direction side of the light guide member 394. The entrance surface 351 is an end surface on the +Z axis direction side of the light guide member 304.

In FIG. 8, the entrance surface 351 is disposed at a position facing the entrance surface 301. In a case where the light guide member 304 has a curved shape or the like, the entrance surface 351 may be disposed at a position optically facing the entrance surface 301. In other words, even when the path in which the light is guided is curved, the center of the path in which the light is guided can be considered to be a straight line.

Supposing that representative light that has been made incident on the entrance surface 351 is a light beam 460, the light beam 460 is emitted forward (in the +Z axis direction) relative to the light guide unit 330 via a reflective surface 363 of the light guide unit 330. The reflective surfaces 363 are optical control surfaces that can reflect the light emitted from the light source unit 11 forward (in the +Z axis direction) relative to the light guide unit 330.

The light beam 460 enters the light guide unit 330 from the entrance surface 351. In FIG. 8, the light beam 460 enters the light guide member 304 from the entrance surface 351. The light beam 460 which has been made incident on the entrance surface 351 travels inside of the light guide member 304 in the −X axis direction. The light beam 460 which has traveled inside of the light guide member 304 reaches a reflective surface 363. The light beam 460 which has reached a reflective surface 363 is reflected by the reflective surface 363. The light beam 460 which has been reflected by the reflective surface 363 travels in the +Z axis direction. The light beam 460 which has traveled in the +Z axis direction reaches the exit surface 302. The light beam 460 which has reached the exit surface 302 is emitted forward. The reflective surfaces 363 are optical control surfaces.

According to this, even when a small number of light guide units are used, the same advantageous effects as those provided by variation 5 illustrated in FIG. 7 can be obtained.

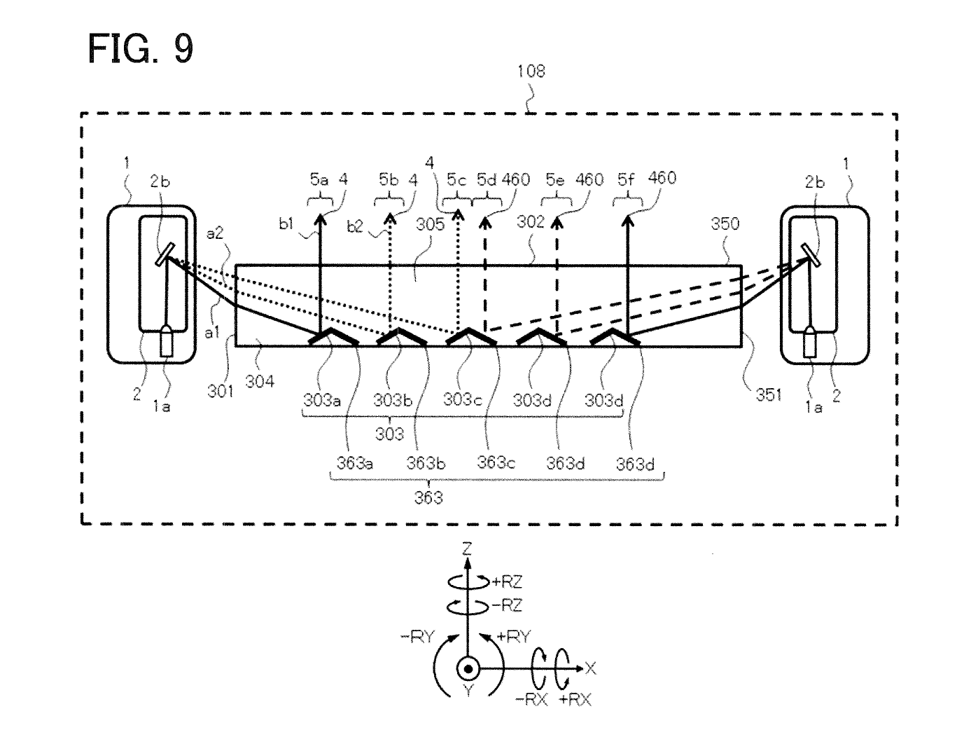

A lighting apparatus 108 illustrated in FIG. 9 has a configuration obtained by providing the lighting apparatus 101 according to variation 3 illustrated in FIG. 5 with two light source units. In addition, light is made incident on two portions of the light guide unit 320.

The lighting apparatus 108 includes a light source unit 1 also on the +X axis side of a light guide unit 350. The light source unit 1 disposed on the +X axis side includes a light adjustment unit 2. The light guide unit 350 includes reflective surfaces 363. Other configurations of the lighting apparatus 108 are the same as those of the lighting apparatus 101.

The light guide unit 350 includes an entrance surface 351. The entrance surface 351 is disposed at a position optically facing an entrance surface 301. In FIG. 9, the entrance surface 351 is formed at an end portion on the +X axis direction side of the light guide unit 350. In FIG. 9, the entrance surface 351 is an end surface on the +X axis direction side of the light guide member 304.

The light guide unit 350 includes the reflective surfaces 363. The reflective surface 363 is disposed on the +X axis direction side of a reflective surface 303. The reflective surface 363 is a surface rotated in the +RY direction from the plane of the entrance surface 351. The reflective surface 363 is obtained by rotating a reflective surface 303 around the Y axis. Other configurations of the reflective surfaces 363 are the same as those of the reflective surfaces 303.

The reflective surface 363 reflects the light beam 460, which has been made incident on the entrance surface 351, toward an exit surface 302. In FIG. 9, the +X axis direction end portion of a reflective surface 303 is in contact with the −X axis direction end portion of a reflective surface 363.

Other configurations of the light guide unit 350 are the same as those of the light guide unit 320.

In FIG. 9, the entrance surface 351 is an end surface on the +X axis direction side of the light guide member 394.

The light beam 460 emitted from the light source unit 1 disposed on the +X axis side reaches the entrance surface 351. The light beam 460 which has been made incident on the entrance surface 351 reaches a reflective surface 363. The light beam 460 which has reached a reflective surface 363 is reflected by the reflective surface 363. The light beam 460 which has been reflected by the reflective surface 363 reaches the exit surface 302. The light beam 460 which has reached the exit surface 302 is emitted from the exit surface 302.

FIG. 9 illustrates an example in which light beams 4 are emitted from light-emitting regions 5a, 5b, 5c and in which light beams 460 are emitted from light-emitting regions 5d, 5e, 5f.

The light-emitting region 5c neighbors the light-emitting region 5d. In this way, since two light source units 1 are provided, the light-emitting regions 5 can easily be disposed close to each other.

Even when a smaller number of light guide members 304 are used, the same advantageous effects as those provided by variation 5 illustrated in FIG. 7 can be provided.

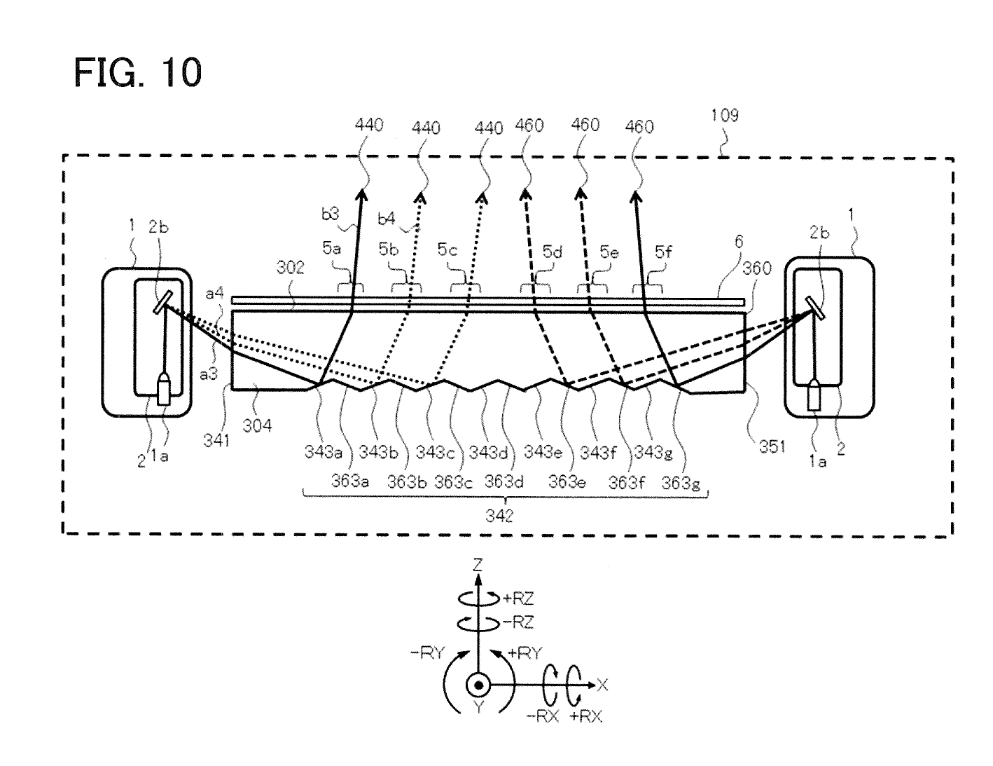

A lighting apparatus 109 illustrated in FIG. 10 has a configuration obtained by providing the lighting apparatus 102 according to variation 4 illustrated in FIG. 6 with two light source units. In addition, light is made incident on two portions of the light guide unit 340.

The lighting apparatus 109 includes a light source unit 1 on the +X axis direction side of a light guide unit 360. The light source unit 1 disposed on the +X axis direction side includes a light adjustment unit 2. The light guide unit 360 includes reflective surfaces 363. Other configurations of the lighting apparatus 109 are the same as those of the lighting apparatus 102.

The light guide unit 360 includes an entrance surface 351. The entrance surface 351 is disposed at a position optically facing an entrance surface 341. In FIG. 10, the entrance surface 351 is formed at an end portion on the +Z axis direction side of the light guide unit 360. In FIG. 10, the entrance surface 351 is an end surface on the +X axis direction side of the light guide member 394 of a light guide member 304.

The light guide unit 360 includes the reflective surfaces 363. The reflective surface 363 is disposed on the +X axis direction side of a reflective surface 343. The reflective surface 363 is a surface rotated in the +RY direction from the plane of the entrance surface 351. The reflective surface 363 is obtained by rotating a reflective surface 343 around the Y axis. Other configurations of the reflective surfaces 363 are the same as those of the reflective surfaces 343.

The reflective surface 363 reflects a light beam 460, which has been made incident on the entrance surface 351, toward an exit surface 302. In FIG. 10, the end portion on the +X axis direction side of the reflective surface 343 is in contact with the end portion on the −X axis direction side of the reflective surface 363.

A prism surface 342 includes the reflective surfaces 343 and the reflective surfaces 363.

Other configurations of the light guide unit 360 are the same as those of the light guide unit 340.

In FIG. 10, the entrance surface 351 is an end surface on the +X axis direction side of the light guide member 304.

The light beam 460 emitted from the light source unit 1 disposed on the +X axis side reaches the entrance surface 351. The light beam 460 which has been made incident on the entrance surface 351 reaches the reflective surface 363. The light beam 460 which has reached the reflective surface 363 is reflected by the reflective surface 363. The light beam 460 which has been reflected by the reflective surface 363 reaches the exit surface 302. The light beam 460 which has reached the exit surface 302 is emitted from the exit surface 302.

FIG. 10 illustrates an example in which light beams 440 are emitted from light-emitting regions 5a, 5b, 5c and in which light beams 460 are emitted from light-emitting regions 5d, 5e, 5f.

According to this, even when a smaller number of light guide members 304 are used, the same advantageous effects as those provided by variation 5 illustrated in FIG. 7 can be provided.

It is possible to adopt a configuration including a plurality of lighting apparatuses 104, 108, or 109 illustrated in FIGS. 8 to 10, each of which has two light source units 1 or two light source units 1 and 11. In other words, for example, a light source unit may be disposed on the +X axis direction side of the light guide unit 300 or 310 illustrated in FIG. 7.

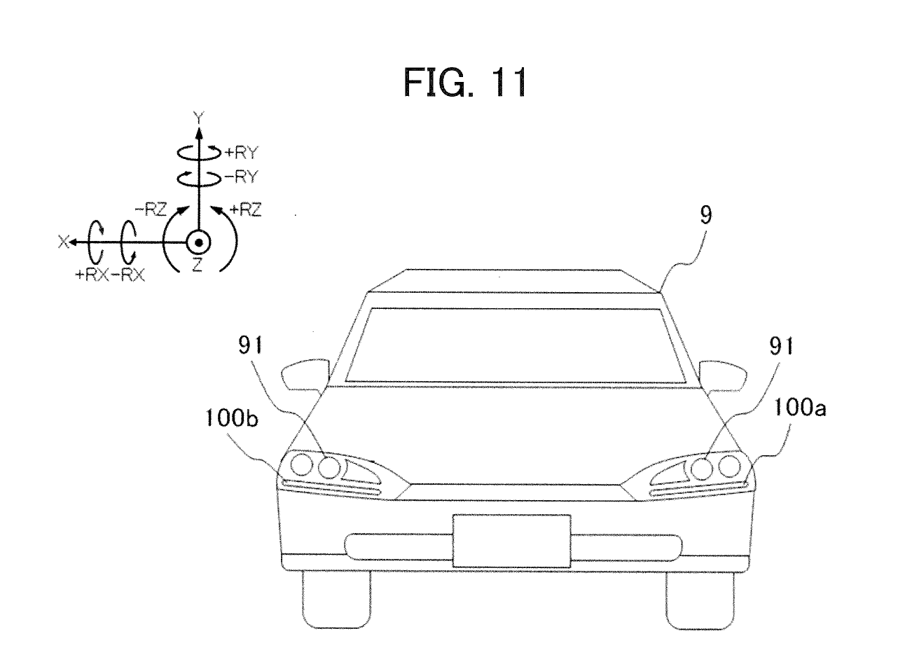

FIG. 11 is a diagram illustrating an example of how the lighting apparatuses 100 to 109 are used. FIG. 11 shows an example of using the lighting apparatuses 100.

The lighting apparatus 100 can be used as a lighting apparatus mounted on a vehicle. In FIG. 11, the lighting apparatuses 100 are disposed under headlights 91, respectively. For example, the lighting apparatuses 100 are used as blinkers.

A lighting apparatus 100a is disposed on a +X axis direction portion of a vehicle 9. A lighting apparatus 100b is disposed on a −X axis direction portion of the vehicle 9.

For example, when the vehicle 9 turns in the +X axis direction, the lighting apparatus 100a turns on as if light sequentially flows from the −X axis direction side to the +X axis direction side. On the other hand, when the vehicle 9 turns in the −X axis direction, the lighting apparatus 100b turns on as if light sequentially flows from the +X axis direction side to the −X axis direction side.

In the above-described embodiments, light can be emitted from either a part or the whole of the light guide unit 370 while the number of the light sources is small. In addition, downsizing of the entire lighting apparatus can be achieved, the number of parts is reduced, and assembling performance is improved.

In other words, by using a light adjustment unit, the position or direction of the light beam emitted from a light source unit is changed. In addition, the light beam is selectively emitted to a reflective surface included in a light guide unit. In this way, it is possible to reduce the number of light sources used to emit light from the light guide unit partially. In addition, it is possible to reduce the number of places where light source units are disposed.

In the above embodiments, the direction of the light which enters the light guide units 300, 320, and 340 and is changed by the light adjustment units 2, is not limited to the direction of the rotation around the Y axis. For example, the direction of the light may be changed translationally in the ±Z axis or the ±Y axis directions. Alternatively, the direction of the light may be rotationally changed around the Z axis or the X axis. Alternatively, the direction of the light may be directions based on a combination of the above examples.

In other words, the light adjustment unit may perform scanning of the light beam in a direction other than the Z axis direction. By the scanning of the light beam, the light adjustment unit can change the path of the light beam traveling inside of the light guide unit. In addition, by changing the position of the light beam emitted from the light adjustment unit, the light adjustment unit can change the path of the light beam traveling inside of the light guide unit. Regarding the change of the position of the light beam emitted from the light adjustment unit, any directions other than the Z axis directions may be applicable.

In the above embodiments, while the direction of the light that enters the light guide units 300, 320, and 340 is changed by using the light adjustment units 2, the direction of the light may be changed in another way. For example, by directly driving the light source unit 1, e.g., by rotating and/or translationally moving the light source unit 1, the direction of the light that enters the light guide units 330, 320, and 340 may be changed.

If no light adjustment unit is used, the light beam may be scanned by rotating the light source unit. Alternatively, the position of the light beam that enters the light guide unit may be changed by moving the light source unit.

In addition, the direction of the light that enters the light guide units 300, 320, and 340 is not limited to the +X axis direction. For example, light may enter these light guide units in the −Y axis direction. In other words, the entrance surface 301 of the light guide unit may be disposed at an arbitrary position on the light guide unit.

In the above embodiments, the light source unit is mainly disposed in the −X axis direction, and the light guide member is formed so as to extend in the X axis direction. After the light beam that has entered the light guide member travels inside of the light guide member in the +X axis direction and is reflected by a reflective surface, the light beam travels in the +Z axis direction.

These are set as an example to facilitate the description. Thus the shapes of the light source units and the light guide members, the paths of the light beams, or other configurations may be changed. In other words, there is design flexibility in the shapes of the light guide members, as described above.

While a two-dimensionally formed configuration is adopted in the above embodiments, a three-dimensionally formed configuration may alternatively be adopted.

While a single lighting apparatus is used in the above embodiments, a plurality of lighting apparatuses may alternatively be used.

While the lighting apparatuses are described as examples in the above embodiments, the present invention is not limited to them.

In addition, the above embodiments may include terms such as “parallel” or “perpendicular” to indicate a positional relationship between parts or a shape of a part. These terms represent that a range in which manufacturing tolerances, assembly variations and the like are considered is included. Thus if the claims includes an expression indicating a positional relationship between parts or a shape of a part, the expression includes the range in which manufacturing tolerances, assembly variations and the like are considered.

While embodiments of the present invention have been described above, the present invention is not limited to these embodiments.

The following contents will be described as appendixes on the basis of the above embodiments.

On the basis of the above embodiments, the following contents will be described as APPENDIX-(1) and APPENDIX-(2). APPENDIX-(1) and APPENDIX-(2) are independently given reference characters. Thus, for example, “Appendix 1” exists for both APPENDIX-(1) and APPENDIX-(2).

### APPENDIX-(1)

### Appendix 1

A lighting apparatus comprising:

a first light source unit including a first light source that emits first light; and

a light guide unit including a first reflective surface that changes a traveling direction of light to produce first reflected light, the light guide unit guiding the first light emitted from the first light source unit to the first reflective surface, wherein

a plurality of first reflective surfaces including the first reflective surface is provided, and

the first light source unit selects one of the plurality of first reflective surfaces and emits the first light to the selected first reflective surface.

### Appendix 2

The lighting apparatus according to appendix 1, wherein the light guide unit includes a plurality of light guide members that guides the first illumination light.

### Appendix 3

The lighting apparatus according to appendix 2, wherein the first reflective surface is formed at an end portion of the light guide member.

### Appendix 4

The lighting apparatus according to appendix 2 or 3, wherein

each of the light guide members includes a first entrance surface that receives the first illumination light, and

the first illumination light that has entered the first entrance surface travels inside the light guide member and reaches the first reflective surface.

### Appendix 5

The lighting apparatus according to any one of appendixes 2 to 4, wherein the first reflected light which has been reflected by one of the first reflective surfaces travels through the other light guide members and is emitted from the light guide unit.

### Appendix 6

The lighting apparatus according to appendix 2 or 3, wherein the first illumination light that has entered the light guide unit travels through two or more of the light guide members and reaches the first reflective surface.

### Appendix 7

The lighting apparatus according to any one of appendixes 2, 3, and 6, wherein the first reflected light which has been reflected by one of the first reflective surfaces travels inside of the light guide member and is emitted from the light guide unit.

### Appendix 8

The lighting apparatus according to appendix 1, wherein

the light guide unit includes a single light guide member, and

the single light guide member includes the plurality of first reflective surfaces.

### Appendix 9

The lighting apparatus according to appendix 8, wherein the plurality of first reflective surfaces is arranged in a direction in which the first illumination light travels inside of the light guide member.

### Appendix 10

The lighting apparatus according to appendix 9, wherein the light guide member includes a first entrance surface that receives the first illumination light and an exit surface that emits the first reflected light which has been reflected by one of the first reflective surfaces.

### Appendix 11

The lighting apparatus according to appendix 10, wherein the plurality of first reflective surfaces is disposed on a surface facing the exit surface of the light guide member.

### Appendix 12

The lighting apparatus according to appendix 10, wherein the plurality of first reflective surfaces is disposed inside the light guide member.

### Appendix 13

The lighting apparatus according to appendix 12, wherein a first reflective surface disposed farther from the first entrance surface than another first reflective surface is disposed closer to the exit surface.

### Appendix 14

The lighting apparatus according to appendix 12, wherein the plurality of first reflective surfaces is equally distanced from the exit surface.

### Appendix 15

The lighting apparatus according to any one of appendixes 10 to 14, including a second light source unit including a second light source that emits second light, wherein

the light guide member includes a second entrance surface that receives the second light at a location facing the first entrance surface and a second reflective surface that reflects the second light that has entered the second entrance surface and changes a traveling direction of the second light.

### Appendix 16

The lighting apparatus according to appendix 15, wherein the second reflective surface is disposed next to one of the first reflective surfaces in the direction of the second entrance surface.

### Appendix 17

The lighting apparatus according to any one of appendixes 8 to 14, including a plurality of pairs of first light source unit and light guide unit, each pair corresponding to the light source unit and the light guide unit.

### Appendix 18

The lighting apparatus according to appendix 17, wherein the first reflected light emitted from one of the plurality of pairs passes through the light guide units of the other pairs.

### Appendix 19

The lighting apparatus according to appendix 17 or 18, wherein

the plurality of pairs includes a second light source unit including a second light source that emits second light, and

the light guide member of the plurality of pairs includes a second entrance surface that receives the second light at a location facing the first entrance surface and a second reflective surface that reflects the second light that has entered the second entrance surface and changes a traveling direction of the second light.

### Appendix 20

The lighting apparatus according to appendix 19, wherein the second reflective surface is disposed next to one of the first reflective surfaces in the direction of the second entrance surface.

### Appendix 21

The lighting apparatus according to any one of appendixes 1 to 20, wherein

the first light source unit includes a plurality of first light sources,

the plurality of first light sources are disposed to correspond to the plurality of first reflective surfaces, respectively, and

the first light emitted from the first light source is reflected by a corresponding one of the first reflective surfaces.

### Appendix 22

The lighting apparatus according to any one of appendixes 1 to 20, wherein the first light source unit rotates to change the traveling direction of the first light emitted from the first light source.

### Appendix 23

The lighting apparatus according to any one of appendixes 1 to 20, wherein the first light source unit moves translationally to change a position of emission of the first light emitted from the first light source.

### Appendix 24

The lighting apparatus according to any one of appendixes 1 to 20, wherein the first light source unit includes a first light adjustment unit that receives the first light and emits the received first light after changing a position or direction of the first light.

### Appendix 25

The lighting apparatus according to appendix 24, wherein the first light adjustment unit includes a container having a reflective surface as its inner surface and a liquid crystal shutter,

the liquid crystal shutter is driven to have a transmission region that allows passage of light and a light-blocking region that blocks passage of light, and

after the light emitted from the first light source enters the container and is reflected by the reflective surface inside the container, the light is emitted from the transmission region of the liquid crystal shutter.

### Appendix 26

The lighting apparatus according to appendix 24, wherein

the first light adjustment unit includes a mirror that changes its inclination,

the light emitted from the first light source is reflected by the mirror for a scanning operation and is emitted from the first light source unit.

### Appendix 27

The lighting apparatus according to any one of appendixes 15, 16, 19, and 20, wherein

the second light source unit includes a plurality of second light sources,

the plurality of second light sources are disposed to correspond to the plurality of second reflective surfaces, respectively, and

the second light emitted from one of the second light sources is reflected by a corresponding one of the second reflective surfaces.

### Appendix 28

The lighting apparatus according to any one of appendixes 15, 16, 19, and 20, wherein the second light source unit rotates to change the traveling direction of the second light emitted from the second light source.

### Appendix 29

The lighting apparatus according to any one of appendixes 15, 16, 19, and 20, wherein the second light source unit moves translationally to change a position of emission of the second light emitted from the second light source.

### Appendix 30

The lighting apparatus according to any one of appendixes 15, 16, 19, and 20, wherein the second light source unit includes a second light adjustment unit that receives the second light and emits the received second light after changing a position or direction of the second light.

### Appendix 31

The lighting apparatus according to appendix 30, wherein

the second light adjustment unit includes a container having a reflective surface as its inner surface and a liquid crystal shutter,

the liquid crystal shutter is driven to have a transmission region that allows passage of light and a light-blocking region that blocks passage of light, and

after the light emitted from the second light source enters the container and is reflected by the reflective surface inside the container, the light is emitted from the transmission region of the liquid crystal shutter.

### Appendix 32

The lighting apparatus according to appendix 30, wherein

the second light adjustment unit includes a mirror that changes its inclination,

the light emitted from the second light source is reflected by the mirror for a scanning operation and is emitted from the second light source unit.

### Appendix 33

A vehicle including the lighting apparatus according to any one of appendixes 1 to 32.

### APPENDIX-(2)

### Appendix 1

A lighting apparatus comprising: a light source; a light guide component that receives light from the light source and guides the light; and a drive device that changes a direction of the light that enters the light guide component, wherein

the light guide component includes a plurality of optical control surfaces that change a traveling direction of the light that enters the light guide component, and

the drive device emits the light that enters the light guide component selectively to one of the plurality of optical control surfaces so that the light from the light source is emitted from an arbitrary region on the light guide component.

### Appendix 2

The lighting apparatus according to appendix 1, wherein

each of the optical control surfaces is a reflective surface.

### Appendix 3

The lighting apparatus according to appendix 1, wherein

each of the optical control surfaces is a prism surface.

### DESCRIPTION OF REFERENCE CHARACTERS

100, 101, 102, 103, 104, 105, 106, 107 lighting apparatus; 1, 10, 11 light source unit; 2, 20, 21 light adjustment unit; 2a, 21a liquid crystal shutter; 2b scanning mirror; 2c optical element; 300, 310, 320, 330, 340, 370, 380, 390 light guide unit; 301, 341, 351, 371, 374i, 381, 384i, 391 entrance surface; 302, 372, 382, 392, 394o exit surface; 303, 303a, 303b, 303c, 303d, 343, 343a, 343b, 343c, 343d, 353, 373, 374r, 383, 384r, 393, 394r reflective surface; 304, 374, 384, 394 light guide member; 305, 355 boundary surface; 342 prism surface; 4, 440, 450, 460, 470 light beam; 5 light-emitting region; 6 optical element; a1, a2, a3, a4 path.

1.-14. (canceled)

15. A lighting apparatus comprising:
A light source unit including a light source that emits-light; and
a light guide unit including a reflective surface that changes a traveling direction of light to produce reflected light and guiding the light emitted from the light source unit to make the light reach the reflective surface, wherein
a plurality of the reflective surfaces is provided,
the light source unit selects one of the plurality of-reflective surfaces and emits the light toward the selected-reflective surface,
the light guide unit includes a light guide member,
the light guide member is a single light guide member, and
the plurality of the reflective surfaces is included in the light guide member.

16. The lighting apparatus according to claim 15, wherein the plurality of reflective surfaces is arranged in a direction in which the illumination light travels inside of the light guide member.

17. The lighting apparatus according to claim 16, wherein the light guide member includes an entrance surface that receives the illumination light and an exit surface that emits the reflected light which has been reflected by one of the reflective surfaces.

18. The lighting apparatus according to claim 17, wherein the plurality of reflective surfaces is disposed on a surface facing the exit surface of the light guide member.

19. The lighting apparatus according to claim 17, wherein the plurality of reflective surfaces is disposed inside the light guide member.

20. The lighting apparatus according to claim 15, wherein
the light source unit includes a plurality of light sources,
the plurality of light sources is disposed to correspond to the plurality of reflective surfaces, respectively, and
the light emitted from one of the light sources is reflected by a corresponding one of the reflective surfaces.

21. The lighting apparatus according to claim 15, wherein the light source unit includes a light adjustment unit that receives the light, changes a position from which the received light is emitted or a direction in which the received light is emitted, and then emits the received light.

22. The lighting apparatus according to claim 16, wherein
the light source unit includes a plurality of light sources,
the plurality of light sources is disposed to correspond to the plurality of reflective surfaces, respectively, and
the light emitted from one of the light sources is reflected by a corresponding one of the reflective surfaces.

23. The lighting apparatus according to claim 17, wherein
the light source unit includes a plurality of light sources,
the plurality of light sources is disposed to correspond to the plurality of reflective surfaces, respectively, and
the light emitted from one of the light sources is reflected by a corresponding one of the reflective surfaces.

24. The lighting apparatus according to claim 18, wherein
the light source unit includes a plurality of light sources,
the plurality of light sources is disposed to correspond to the plurality of reflective surfaces, respectively, and
the light emitted from one of the light sources is reflected by a corresponding one of the reflective surfaces.

25. The lighting apparatus according to claim 19, wherein
the light source unit includes a plurality of light sources,
the plurality of light sources is disposed to correspond to the plurality of reflective surfaces, respectively, and
the light emitted from one of the light sources is reflected by a corresponding one of the reflective surfaces.

26. The lighting apparatus according to claim 16, wherein the light source unit includes a light adjustment unit that receives the light, changes a position from which the received light is emitted or a direction in which the received light is emitted, and then emits the received light.

27. The lighting apparatus according to claim 17, wherein the light source unit includes a light adjustment unit that receives the light, changes a position from which the received light is emitted or a direction in which the received light is emitted, and then emits the received light.

28. The lighting apparatus according to claim 18, wherein the light source unit includes a light adjustment unit that receives the light, changes a position from which the received light is emitted or a direction in which the received light is emitted, and then emits the received light.

29. The lighting apparatus according to claim 19, wherein the light source unit includes a light adjustment unit that receives the light, changes a position from which the received light is emitted or a direction in which the received light is emitted, and then emits the received light.
